(19) United States
(12) Patent Application Publication
(10) Pub. No.: US 2021/0377249 A1
(43) Pub. Date: Dec. 2, 2021

(54) VERIFICATION METHOD AND TRANSACTION VERIFICATION METHOD

(71) Applicant: KINGMAX SEMICONDUCTOR INC., Hsinchu County (TW)

(72) Inventor: YUNG-HUA OUYANG, HSINCHU COUNTY (TW)

(21) Appl. No.: 16/987,729

(22) Filed: Aug. 7, 2020

(30) Foreign Application Priority Data
Jun. 2, 2020 (TW) 109118392

(51) Int. Cl. H04L 29/06; G06F 16/23; H04L 9/32; G06Q 20/06

(52) U.S. Cl. CPC H04L 63/083; G06Q 20/065; H04L 9/3247; G06F 16/2379

(57) ABSTRACT

A verification method and a transaction verification method are provided. The verification method applicable for a secure device and an unsecure device utilizes the secure device to generate a match information for a user to see one-to-one substitution relations between a plurality of first verification data and a plurality of second verification data. When the user, after seeing the match information, selects the plurality of second verification data on the unsecure device, the unsecure device transmits a plurality of input data to the secure device, and the secure device converts the plurality of input data into a plurality of to-be-verified passwords according to the match information. The secure device then determines whether or not the plurality of to-be-verified passwords match with a plurality of pre-stored password data in the secure device.

### CROSS-REFERENCE TO RELATED PATENT APPLICATION

This application claims the benefit of priority to Taiwan Patent Application No. 109118392, filed on Jun. 2, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a verification method and a transaction verification method, and more particularly to a verification method and a transaction verification method that utilize a secure device to verify an unsecure device.

### BACKGROUND OF THE DISCLOSURE

Currently, it is common to conduct banking transactions over the Internet through cellphones and computers, and dynamic keyboards are used to prevent keystroke logging. However, password data used for verification of user identity are eventually mostly temporarily either stored in the cellphones or the computers, before being transmitted to remote servers for verification, or, even when the password data are converted before being transmitted, a substitution table used for password conversion is still stored in the cellphones or computers of a user. Therefore, the password data of the user can still be acquired through peeking, unauthorized recording, etc., which causes security issues. Moreover, in the process of transmitting transaction data, a transaction can be under a man-in-the-middle (MITM) attack, which tampers the transaction and results in inexplicable losses.

### SUMMARY OF THE DISCLOSURE

In response to the above-referenced technical inadequacies, the present disclosure provides a verification method and a transaction verification method that mainly focus on enhancing the security of the commonly seen password data and password conversion substitution tables used for identity verification, which are temporarily stored in cellphones and computers, and may easily be subject to unwanted monitoring, keystroke logging, or a man-in-the-middle (MITM) attack that tampers with the transaction data.

In one aspect, the present disclosure provides a verification method that is applicable for a secure device and an unsecure device. The secure device includes a display unit and a processing module. The unsecure device is capable of generating an input information according to an operation of a user, and the processing module of the secure device receives the input information that is transmitted by the unsecure device. The verification method includes a verification code presenting step: utilizing the processing module of the secure device to generate a match information, with the display unit presenting the match information, the match information including N of first verification data that are different from one another and N of second verification data that are different from one another, one-to-one substitution relations between each of N of the first verification data and each of N of the second verification data being presented on the display unit by the match information, and the one-to-one substitution relations between each of N of the first verification data and each of N of the second verification data being not entirely identical each time the one-to-one substitution relations are generated by the processing module; executing, when the secure device receives the input information within a predetermined period of time after the match information is presented on the display unit, the following steps: a verification step which includes utilizing the processing module of the secure device to substitute M of the first verification data for M of input data of the input information according to the match information, with the processing module defining M of the first verification data generated through the substitution as M of to-be-verified password data according to the match information, the unsecure device presenting P of the second verification data, and the unsecure device, according to an operation of the user, determining which of the second verification data are selected by the user and generating M of the corresponding input data, N being a positive integer greater than 1, and M being a positive integer; and utilizing the processing module of the secure device to determine whether or not M of the to-be-verified password data match with M of password data that are stored in the secure device in advance; wherein when the processing module of the secure device determines that M of the to-be-verified password data match with M of the password data, the secure device transmits a verification-successful information to the unsecure device, and wherein when the processing module of the secure device determines that M of the to-be-verified password data do not match with M of the password data, the secure device transmits a verification-failed information to the unsecure device.

In another aspect, the present disclosure provides a verification method that is applicable for a secure device and an unsecure device. The secure device includes a display unit and a processing module. The unsecure device is capable of generating an input information according to an operation of a user, and the processing module of the secure device receives the input information that is transmitted by the unsecure device. The verification method includes a verification code presenting step: utilizing the processing module of the secure device to generate a match information, the match information including N of first verification data that are different from one another and N of second verification data that are different from one another, one-to-one substitution relations between each of N of the first verification data and each of N of the second verification data are presented on the display unit by the match information, and the one-to-one substitution relations between each of N of the first verification data and each of N of the second verification data being not entirely identical each time the one-to-one substitution relations are generated by the processing module; executing, when the secure device receives the input information within a predetermined period of time after the match information is presented on the display unit, the following steps: a verification step which includes utilizing the processing module of the secure device to substitute M of the first verification data for M of input data of the input information according to the match information, with the processing module defining M of the first verification data generated through the substitution as M of to-be-verified password data according to the match information, the unsecure device presenting P of the second verification data, and the unsecure device, according to an operation of the user, determining which of the second verification data are selected by the user, and generates M of the corresponding input data, with N being a positive integer greater than 1, and M being a positive integer; and utilizing the processing module of the secure device to determine whether or not M of the to-be-verified password data match with M of password data of the input information; wherein when the processing module of the secure device determines that M of the to-be-verified password data match with M of the password data, the secure device transmits a verification-successful information to the unsecure device, and wherein when the processing module of the secure device determines that M of the to-be-verified password data do not match with M of the password data, the secure device transmits a verification-failed information to the unsecure device;

In yet another aspect, the present disclosure provides a transaction verification method that is applicable for a secure device and an unsecure device. The secure device includes a first display unit and a first processing module, and the unsecure device includes a second display unit, a second processing module, and an input unit. The transaction verification method includes a transaction information inputting step: utilizing, according to an operation of the input unit by a user, the second processing module of the unsecure device to generate a corresponding transaction data; utilizing the second processing module of the unsecure device to execute a R-bit based transfer encoding algorithm that converts the transaction data into an encoded information that is R-bit based, and controlling the second display unit to present K characters of the encoded information, with R being a positive integer greater than 1, M characters of the encoded information presented by the second display unit being defined as M of the password data, and K being a positive integer greater than or equal to M; a transaction signature request step: transmitting, after the second display unit of the unsecure device presents M of the password data, a transaction signature request information to the secure device through the unsecure device; a transaction verification code presenting step: utilizing the secure device to receive the transaction signature request information that is transmitted by the unsecure device; controlling the first processing module of the secure device to generate a match information, with the first display unit presenting the match information, the match information including N of first verification data that are different from one another and N of second verification data that are different from one another, one-to-one substitution relations between each of N of the first verification data and each of N of the second verification data being presented on the first display unit by the match information, N being a positive integer that is greater than or equal to 1, M being a positive integer, and the one-to-one substitution relations between each of N of the first verification data and each of N of the second verification data being not entirely identical each time the one-to-one substitution relations are generated by the first processing module; and executing a signature step, when the secure device receives a to-be-signed information that is transmitted by the unsecure device, within a predetermined period of time after the first display unit presents the match information, with the input unit presenting P of the second verification data, the second processing module of the unsecure device determining which of the second verification data are selected by the user through the input unit, and then generating M of the corresponding input data, and the second processing module integrating M of the input data and the encoded information into the to-be-signed information; the signature step including: utilizing the first processing module of the secure device to substitute M of the first verification data for M of the input data of the to-be-signed information according to the match information, with the first processing module defining M of the first verification data generated through the substitution as M of to-be-verified password data according to the match information; utilizing the first processing module to determine whether or not M of the to-be-verified password data match with M of the password data; when the first processing module of the secure device determines that M of the to-be-verified password data match with M of the password data, the first processing module digitally signs the encoded information, and then transmits the digitally signed encoded information back to the unsecure device; when the first processing module of the secure device determines that M of the to-be-verified password data do not match with M of the password data, the first processing module transmits a signature-failed information to the unsecure device.

Therefore, by virtue of the verification method and the transaction verification method of the present disclosure, when the user is in the process of identity verification by using a secure device or unsecure device, even if the operation process of the user is monitored or keylogged, an unauthorized third party still cannot directly perform identity verification through the unsecure device. Moreover, even if the unauthorized third party has seen the operation process of the user, and acquired the secure devices and the unsecure devices, it remains impossible for such a third party to directly perform identity verification through the secure devices and the unsecure devices.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a flowchart of a verification method in a first embodiment of the present disclosure.

FIG. 2 is a block diagram of a secure device and an unsecure device in the verification method in the first embodiment of the present disclosure.

FIG. 3 to FIG. 5 are each one of schematic views of a process of the first embodiment of the verification method that is executed by the secure device of the present disclosure.

FIG. 6 to FIG. 10 are each one of the schematic views of the process of the first embodiment of the verification method that is executed by the secure device and the unsecure device of the present disclosure.

FIG. 11 is one of the schematic views of the process of the first embodiment of the verification method that is executed by the secure device and the unsecure device of the present disclosure.

FIG. 12 to FIG. 14 are each one of the schematic views of the process of the first embodiment of the verification method that is executed by the secure device and the unsecure device of the present disclosure.

FIG. 15 is a flowchart of a verification method in a second embodiment of the present disclosure.

FIG. 16 is a block diagram of the secure device and the unsecure device in the verification method in the second embodiment of the present disclosure.

FIG. 17A and FIG. 17B are flowcharts of a transaction verification method of the present disclosure.

FIG. 18 to FIG. 21 are each one of the schematic views of the process of the transaction verification method that is executed by the secure device and the unsecure device of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms do not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

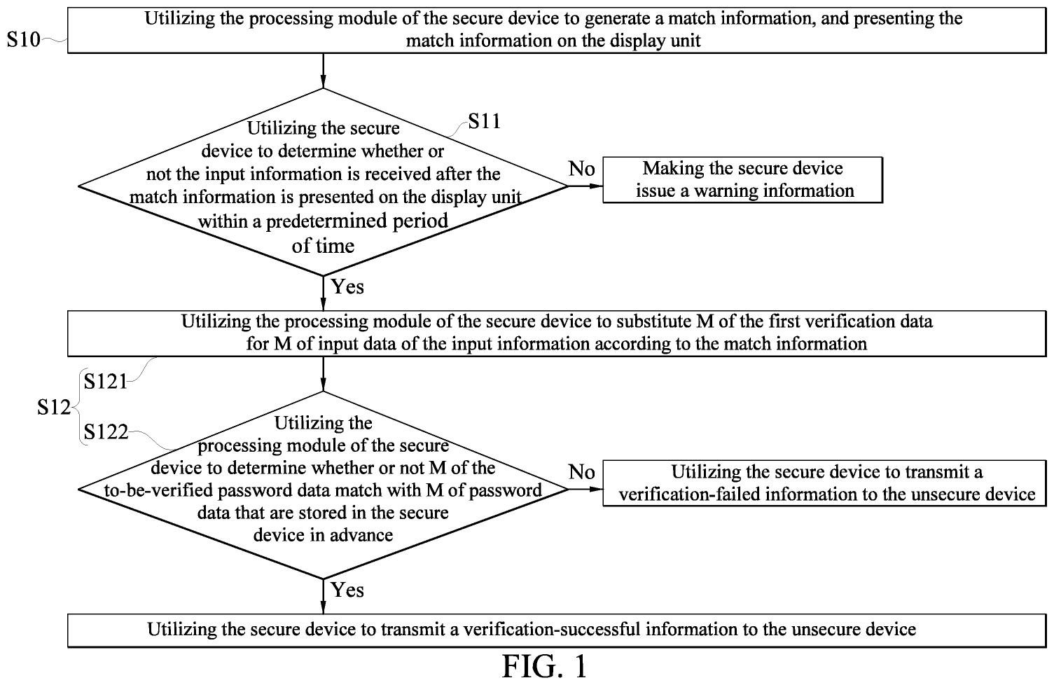

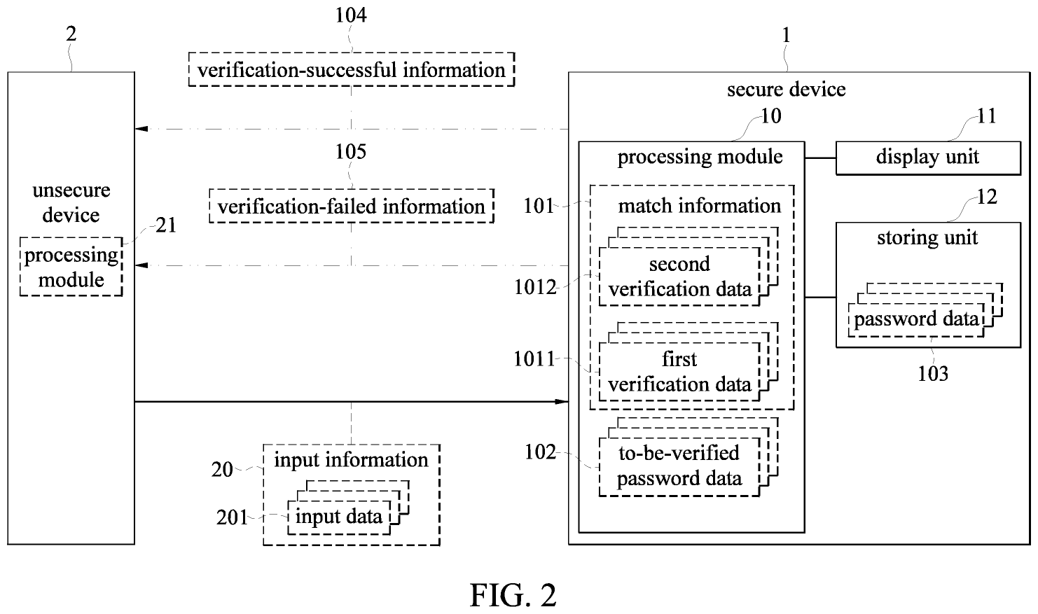

Reference is made to FIG. 1, which is a flowchart of a verification method in a first embodiment of the present disclosure. Reference is made to FIG. 2, which is a block diagram of a secure device and an unsecure device in the verification method in the first embodiment of the present disclosure. The verification of the present disclosure is applicable for a secure device 1 and an unsecure device 2. The secure device 1 includes a processing module 10 and a display unit 11. The unsecure device 2 can generate an input information 20 according to an operation of a user, and the processing module 10 of the secure device 1 can receive the input information 20 transmitted by the unsecure device 2. In practice, the secure device 1 and the unsecure device 2 can wirelessly transmit information to each other through any wireless communication technology. For example, communication can be made between the secure device 1 and the unsecure device 2 through wireless communication technologies, e.g., Bluetooth®, Wi-Fi and ZigBee®.

In practice, the secure device 1 can be a portable electronic device, such as a smart card, which is convenient for the user to carry, the processing module 10 can be a microprocessor, and the unsecure device 2 can be, e.g., a smartphone, a laptop computer, a tablet computer, and a desktop computer, but the present disclosure is not limited thereto. According to the actual form of the unsecure device 2, the unsecure device 2 can include an input device (e.g., a keyboard, a mouse, a touchscreen, and a touchpad), for the user to operate. According to the operation of the user with respect to the input device, a processing module 21 of the unsecure device 2 can generate the corresponding input information 20.

The verification method includes:

a verification code presenting step S10:
utilizing the processing module 10 of the secure device 1 to generate a match information 101, the match information 101 including N of first verification data 1011 that are different from one another and N of second verification data 1012 that are different from one another, one-to-one substitution relations between each of N of the first verification data 1011 and each of N of the second verification data 1012 being presented on the display unit 11 by the match information 101, with N being a positive integer greater than 1 and M being a positive integer, and the one-to-one substitution relations between each of N of the first verification data 1011 and each of N of the second verification data 1012 being not entirely identical each time the one-to-one substitution relations are generated by the processing module 10;

a determination step S11:
utilizing the secure device 1 to determine whether or not the input information 20 is received after the match information 101 is presented on the display unit 11, and executing the following steps, when the secure device 1 receives the input information 20 within a predetermined period of time:

a verification step S12, including:
Step S121: utilizing the processing module 10 of the secure device 1 to substitute M of the first verification data 1011 for M of input data 201 of the input information 20 according to the match information 101, with the processing module 10 defining M of the first verification data 1011 generated through the substitution as M of to-be-verified password data 102 according to the match information 101, the unsecure device 2 presenting P of the second verification data 1012, and the unsecure device 2, according to an operation of the user, determining which of the second verification data 1012 are selected by the user and generating M of the corresponding input data 201; Step S122: utilizing the processing module 10 of the secure device 1 to determine whether or not M of the to-be-verified password data 102 match with M of password data 103 that are stored in the secure device 1 in advance.

When the processing module 10 of the secure device 1 determines that M of the to-be-verified password data 102 match with M of the password data 103, the secure device 1 transmits a verification-successful information 104 to the unsecure device 2. When the processing module 10 of the secure device 1 determines that M of the to-be-verified password data 102 do not match with M of the password data 103, the secure device 1 transmits a verification-failed information 105 to the unsecure device 2.

In practice, in the verification code presenting step S10, the display unit 11 of the secure device 1 can present each of the first verification data 1011 in a form of a character string, and the display unit 11 of the secure device 1 can present each of the second verification data 1012 in a form of a picture. The form of a character string can be of any text and symbol, and the form of a picture can be any graph and pattern. For example, when the display unit 11 of the secure device 1 is presenting the first verification data 1011, corresponding Arabic numerals, Chinese numerals, mathematical symbols, English alphabets, Greek alphabets, etc., can be presented, and when the display unit 11 of the secure device 1 is presenting the second verification data 1012, geometric shapes, such as circles, ovals, triangles, rectangles, and rhombuses, can be presented. In practice, as long as the user is able to recognize the difference between the first verification data 1011 and the second verification data 1012 presented by the display unit 11, the first verification data 1011 and the second verification data 1012 can be presented in any form by the display unit 11.

It is worth mentioning that, in the verification code presenting step S10, the processing module 10 can each time generate N of the first verification data 1011 and N of the second verification data 1012 that are identical, with one-to-one substitution relations between each of N of the first verification data 1011 and each of N of the second verification data 1012 in the match information 101 generated by the processing module 10 being not identical each time. That is to say, the one-to-one substitution relations between each of N of the first verification data 1011 and each of N of the second verification data 1012 in the match information 101 are at least partially not identical each time the match information 101 is generated by the processing module 10.

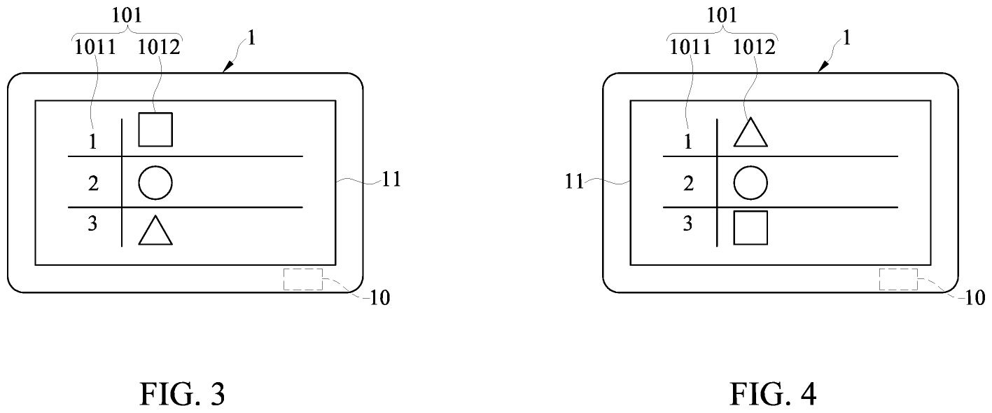

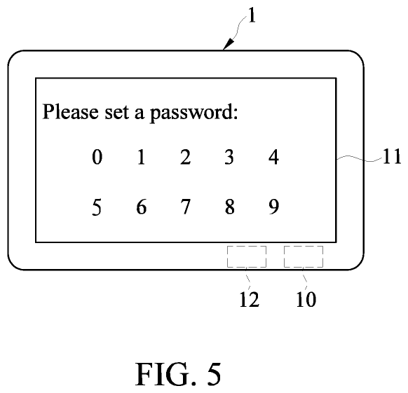

References are made to FIG. 3 and FIG. 4, which are respectively one of the schematic views of the process of the first embodiment of the verification method that is executed by the secure device of the present disclosure. As shown in FIG. 3, when the processing module 10 of the secure device 1 generates the match information 101 for the first time, and controls the display unit 11 to present the match information 101, the user is able to see a table, which is the match information 101, on the display unit 11, and the user is able to see that an Arabic numeral 1 (first verification data 1011) and a rectangle picture (second verification data 1012) are substituted for each other, an Arabic numeral 2 and a circle picture are substituted for each other, and an Arabic numeral 3 and a triangle picture are substituted for each other.

As shown in FIG. 4, when the processing module 10 of the secure device 1 generates the match information 101 again and presents the match information 101 on the display unit 11, the user is able to see from the table presented on the display unit 11 (the match information 101) that there are the same three Arabic numerals (the first verification data 1011) and the same three pictures (the second verification data 1012). However, in the table that is shown on the display unit 11, the user is able to clearly see that while the Arabic numeral 2 and the circle picture can still be substituted for each other, the substitution relations have changed for the Arabic numerals 1 and 3 such that the Arabic numeral 1 and the triangle picture are substituted for each other, and the Arabic numeral 3 and the rectangle picture are substituted for each other. In other words, each time the secure device 1 executes the verification code presenting step S10, the display unit 11 can always present the three identical Arabic numerals and the three identical pictures, but the user is able to clearly see from the match information 101 presented on the display unit 11 that the substitution relations among those three Arabic numerals and three pictures are at least partially not identical.

In practice, in the determination step S11, when the secure device 1 does not receive the input information 20 within the predetermined period of time after the display unit 11 presents the match information 101, the verification step S12 can be not executed, and the secure device 1 can be controlled to issue a warning information to remind the user that the secure device 1 has not yet received the input information 20 at the time being. To be specific, information such as “The secure device has not yet received the input information.” and “Please select the pictures that are corresponding to the passwords on the unsecure device (cellphone).” can be presented on the display unit 11 of the secure device 1. Moreover, the secure device 1 can remind the user by making a specific notification sound or beep, or emitting a specific colored light.

In a different embodiment, in the determination step S11, when the secure device 1 does not receive the input information 20 within the predetermined period of time after the display unit 11 presents the match information 101, in addition to not executing the verification step S12, the verification code presenting step S10 can be executed again, such that the processing module 10 of the secure device 1 generates a new match information 101. That is to say, when the secure device 1 does not receive the input information 20 within the predetermined period of time, such as three minutes, after the display unit 11 presents the match information 101, the display unit 11 of the secure device 1 presents the new match information 101. When the display unit 11 of the secure device 1 is presenting the match information 101, a countdown of the predetermined period of time can also be presented simultaneously.

As mentioned above, in a specific embodiment, the processing module 10 of the secure device 1 can stop generating the match information 101 after repetitively generating a predetermined number of times of the match information 101. For example, when the predetermined period of time is three minutes, the processing module 10 can stop generating the match information 101 after generating the match information 101 twice without receiving the input information 20; that is to say, when the user does not transmit the input information 20 to the secure device 1 through the unsecure device 2 in six minutes, the secure device 1 then stops generating the match information 101. When the secure device 1 does not present the match information 101, the user is able to have the secure device 1 execute the verification code presenting step S10 once again through pressing specific buttons and switches of the secure device 1. Moreover, the user is able to transmit the input information 20 to the secure device 1 through operating the unsecure device 2, so that the secure device 1 can execute the verification code presenting step S10 again.

It is worth mentioning that, in practice, the verification method can include, before the verification step S12, a password pre-storing step: storing M of the password data 103 in the secure device 1. In the password pre-storing step, the secure device 1 can receive M of the password data 103 that are transmitted from the unsecure device 2 or an external device, and store the password data 103 in a storing unit 12 of the secure device 1. For example, the secure device 1 can include an input unit, such as a physical button and a touchscreen, and the user is able to set M of the password data 103 in the secure device 1 through operating the input unit, and store the password data 103 in the storing unit 12 (e.g., a memory of any type) of the secure device 1. Moreover, the secure device 1 can be wirelessly connected to the unsecure device 2 and other external devices, such that the user is able to have M of the password data 103 generated through operating the input unit of the unsecure device 2 (e.g., a mouse, a keyboard, and a touchscreen), or an input unit of an external device, and then transmitted to the secure device 1.

In practice, when the secure device 1 is purchased by the user and being used for the first time, the user must operate the secure device 1 to set and store M of the password data 103 in the secure device 1, and M of the password data 103 can be set according to personal preferences of the user within a predetermined range.

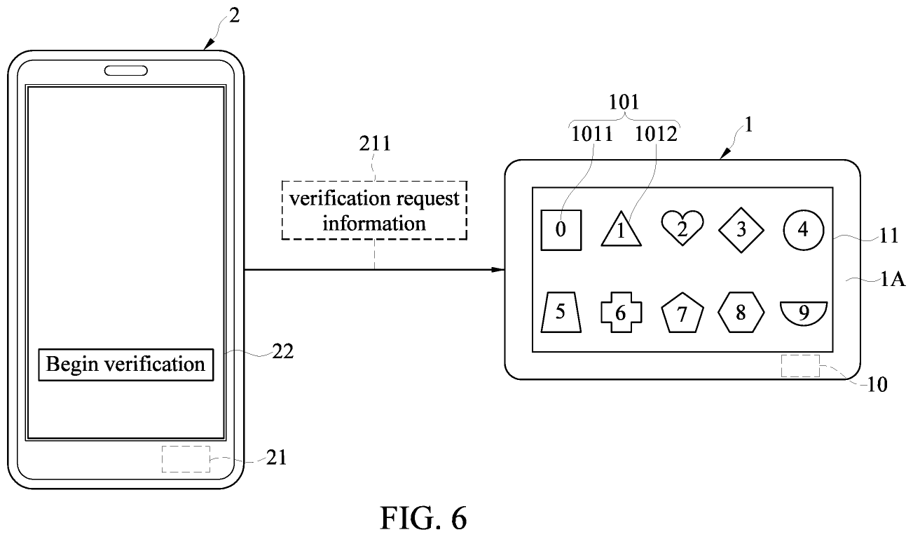

Reference is made to FIG. 5, which is the schematic view of the secure device executing the password pre-storing step of the present disclosure. When the secure device 1 executes the password pre-storing step, the secure device 1 can present information, e.g., “Please set a password.” and Arabic numerals 0 to 9 on a touchscreen, and the user can select M of the Arabic numerals as the password data 103, according to his/her preferences. The touchscreen is the display unit 11 that is integrated with the input unit. In a different embodiment, the secure device 1 can have 10 buttons that are independent from the display unit 11, which are respectively labeled with Arabic numerals 0 to 9 on the surface.

It should be noted that, in the verification code presenting step S10, N of the first verification data 1011 presented by the secure device 1 must include M of the password data 103, and a number of N of the first verification data 1011 must be greater than or equal to that of M of the password data 103, as in N≥M. For example, when the user sets four of the password data 103 as 1, 2, 3 and 4 in the verification code presenting step S10, the display unit 11 of the secure device 1 then presents more than four of the Arabic numerals (the first verification data 1011) and more than four of the pictures (the second verification data 1012). That is to say, the display unit 11 of the secure device 1 can present four Arabic numerals, 1, 2, 3, and 4, along with four pictures; alternatively, the display unit 11 of the secure device 1 can present six Arabic numerals, 0, 1, 2, 3, 4, and 5, along with six pictures.

In an embodiment that the number of the first verification data 1011 presented by the secure device 1 is each time more than that of the password data 103, as in N>M, among N of the first verification data 1011 presented by the display unit 11 of the secure device 1, rest of the first verification data 1011 that are not corresponding to the password data 103 can be generated randomly by the processing module 10 of the secure device 1 each time the first verification data 1011 is presented on the display unit 11. For example, assuming that the four pre-stored password data 103 of the secure device 1 is 1, 2, 3 and 4, and that the secure device 1 has ten Arabic numerals pre-stored (ten of the first verification data 1011), and the secure device 1 is to execute the verification code presenting step S10, when the display unit 11 presents six of the first verification data 1011, the display unit 11 of the secure device 1 definitely presents 1, 2, 3, and 4, and the other two Arabic numerals are then selected randomly from the rest of the pre-stored Arabic numerals. That is, when the user executes the verification code presenting step S10 for the first time with the secure device 1, six Arabic numerals, 1, 2, 3, 4, 5, and 6, may be seen on the display unit 11, and when the user executes the verification code presenting step S10 the second time with the secure device 1, six Arabic numerals, 0, 1, 2, 3, 4, and 6, may be seen on the display unit 11.

In a specific implementation of this embodiment, when the secure device 1 is executing the verification code presenting step S10, the number of the first verification data 1011 generated by the processing module 10 can be not entirely identical each time. For example, assuming that the user sets four of the password data 103, when the secure device 1 is executing the verification code presenting step S10 for the first time, four of the first verification data 1011 can be displayed on the display unit 11; and when the secure device 1 is executing the verification code presenting step S10 for another time, four or more than four of the first verification data 1011 can be presented on the display unit 11.

In one of the implementations of this embodiment, the verification method can further include, before the verification code presenting step S10, a verification request transmitting step: utilizing the unsecure device 2 to transmit a verification request to the secure device 1. In the verification code presenting step S10, before utilizing the processing module 10 of the secure device 1 to generate the match information 101, a verification code receiving step is further included: utilizing the processing module 10 to receive the verification request. That is to say, after the unsecure device 2 transmits the verification request, the secure device 1 controls the processing module 10 to generate the match information 101, and presents N of the first verification data 1011 and N of the second verification data 1012 on the display unit 11.

In one of the implementations of this embodiment, the verification method can further include, before the verification code presenting step S10, a secure device request transmitting step: utilizing the secure device 1 to transmit a request information to the unsecure device 2. When the secure device 1 receives a response information transmitted by the unsecure device 2 within a predetermined period of time, the secure device 1 executes the verification code presenting step S10. That is to say, before the display unit 11 of the secure device 1 presents N of the first verification data 1011 and N of the second verification data 1012, the secure device 1 transmits the request information to the unsecure device 2. When the unsecure device 2 receives the request information and responds with the response information, the secure device 1 then presents N of the first verification data 1011 and N of the second verification data 1012; otherwise, the secure device 1 does not present N of the first verification data 1011 and N of the second verification data 1012.

In one of the implementations of this embodiment, the secure device 1 can further include an input unit, e.g., a variety of physical buttons and touchscreens. The verification method can further include, before the verification code presenting step S10, a verification code presenting request step: utilizing the processing module 10 of the secure device 1 to detect whether or not the input unit of the secure device 1 is operated. When the processing module 10 of the secure device 1 determines that the input unit of the secure device 1 is operated, the secure device 1 then executes the verification code presenting step S10; otherwise, the secure device 1 does not execute the verification code presenting step S10.

In practice, the unsecure device 2 as provided by the verification method of the present disclosure can include a display unit, and the display unit of the unsecure device 2 can present P of the second verification data 1012 before or after the display unit 11 of the secure device 1 presents the match information 101, and the user can simultaneously see the second verification data 1012 in the same or different quantities on the display unit 11 of the secure device 1 and the display unit of the unsecure device 2. For example, assuming that the secure device 1 has pre-stored four of the password data 103, and the secure device 1 is also pre-stored with ten pictures that are different from one another, the display unit 11 of the secure device 1 randomly presents five of the ten pictures (the second verification data 1012) in the verification code presenting step S10, and the display unit of the unsecure device 2 presents the ten pictures (the second verification data 1012) that are identical to the ten pre-stored pictures of the secure device 1. Moreover, when the display unit 11 of the unsecure device 2 presents P of the second verification data 1012, the processing module 21 of the unsecure device 2 can detect the operation of the user with respect to the unsecure device 2 and then determine which of the second verification data 1012 are selected, and generates M of the input data 201 accordingly.

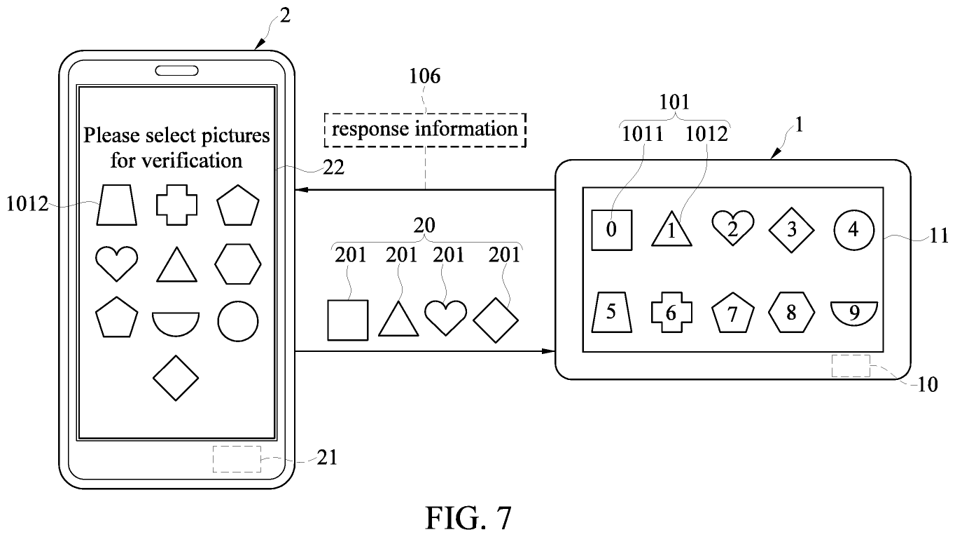

References are made to FIG. 6 to FIG. 8, which are schematic views of the first embodiment of the verification method of the present disclosure being applied to cellphones and smart cards. In the following description, examples are made in which the secure device 1 is a smart card, the unsecure device 2 is a cellphone, N is ten, and M is four. Moreover, in order to more clearly and concisely indicate that the secure device 1 is the smart card and the unsecure device 2 is the cellphone, descriptions in the following are presented as smart card (1) and cellphone (2).

smart card (1) includes a body 1A, the processing module 10 and the display unit 11. The body 1A can be a plastic thin-film structure, the processing module 10 is disposed in the body 1A, and the processing module 10 can be a microprocessor of any type. The display unit 11 is affixed on the body 1A and electronically connected to the processing module 10. The display unit 11 can be controlled by the processing module 10, so as to present pictures, character strings, etc.

The cellphone (2) includes the processing module 21 and a touchscreen 22. The processing module 21 of the cellphone (2) and the processing module 10 of the smart card (1) can transmit information to each other through wireless technologies, e.g., Bluetooth®. In a different embodiment, the cellphone (2) can be without the touchscreen 22, but includes physical buttons (input units) and non-touch screens (display units).

Assuming that the user is to use a certain application for transactions or relatively confidential operations, for the sake of safety, the application can request the user to first verify his/her identity utilizing the smart card (1). As shown in FIG. 6, the user can first operate the touchscreen 22 of the cellphone (2), such that the cellphone (2) generates a verification request information 211 and transmits the verification request information 211 to the smart card (1). For example, through pressing a virtual button that presents “Begin verification” on the touchscreen 22, the user can activate the processing module 21 of the cellphone (2) to transmit the verification request information 211 to the smart card (1) under a circumstance that the certain application is executed on the cellphone (2).

When the smart card (1) receives the verification request information 211 transmitted by the cellphone (2), the smart card (1) then executes the verification code presenting step S10, so that the user can see ten Arabic numerals 0 to 9 (first verification data 1011), and ten pictures that are different from one another (second verification data 1012) on the display unit 11 of the smart card (1), with the ten pictures and the ten Arabic numerals placed on top of one another in a manner that the user can clearly see the substitution relations between each of the pictures and each of the Arabic numerals. To be more specific, as shown in FIG. 6, what is presented on the display unit 11 of the smart card (1) indicates the substitution relations between each of the pictures and each of the Arabic numerals for the user, in which there are substitution relations between the Arabic numeral 0 and a rectangle picture, the Arabic numeral 1 and a triangle-shaped picture, the Arabic numeral 2 and a heart-shaped picture, the Arabic numeral 3 and a rhombus picture, the Arabic numeral 4 and a circle picture, the Arabic numeral 5 and a trapezoid picture, the Arabic numeral 6 and a cross-shaped picture, the Arabic numeral 7 and a pentagon picture, the Arabic numeral 8 and a hexagon picture, and the Arabic numeral 9 and a semicircle picture.

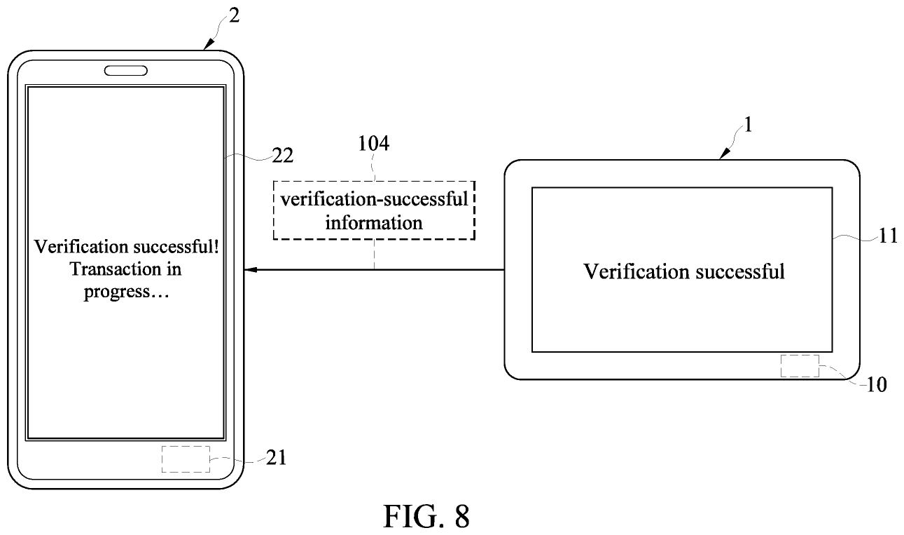

As shown in FIG. 7, when the processing module 10 of the smart card (1) generates the ten Arabic numerals and the ten pictures (the afore-mentioned first verification data 1011), the smart card (1) can respond to the cellphone (2) with a response information 106, and then the processing module 21 of the cellphone (2) receives the response information 106 and controls the touchscreen 22 to present the ten pictures (the second verification data 1012), such that the user can see the identical ten pictures (the second verification data 1012) simultaneously on the cellphone (2) and the smart card (1). That is to say, the cellphone (2) executes the afore-mentioned verification request transmitting step before the smart card (1) executes the verification code presenting step S10, and the smart card (1) executes the afore-mentioned verification code receiving step before the verification code presenting step S10.

Assuming that the four pre-stored password data of the smart card (1) are 1, 2, 3, and 4, the user is able to see the match information 101 (i.e., the ten Arabic numerals and the ten pictures) presented on the smart card (1), and find out that the Arabic numerals, 1, 2, 3, and 4 (the first verification data 1011), respectively correspond to the triangle picture, the heart-shaped picture, the rhombus picture, and the circle picture (the second verification data 1012) at that specific time. After that, the user can sequentially click on the triangle picture, the heart-shaped picture, the rhombus picture, and the circle picture (the second verification data 1012) on the touchscreen 22. The processing module 21 of the cellphone (2) then generates the input information 20 correspondingly, and the input information 20 includes four of the input data 201 that are corresponding to the four pictures clicked on by the user sequentially.

When the processing module 21 of the cellphone (2) transmits the input information 20 to the smart card (1), the processing module 10 of the smart card (1), according to the match information 101, converts the four of the input data 201 included in the input information 20 into the four Arabic numerals, 1, 2, 3, and 4 (the first verification data 1011 and the to-be-verified password data 102). After that, the processing module 10 of the smart card (1) determines whether or not the four Arabic numerals that are converted from the four of the input data 201 are identical to the four password data 103 that are pre-stored in the smart card (1).

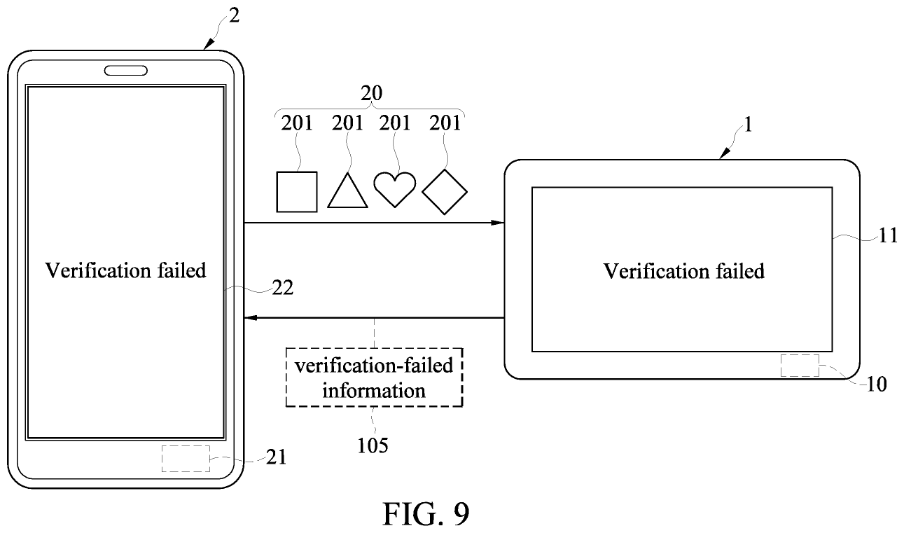

When the processing module 10 of the smart card (1) determines that the four Arabic numerals that are converted from the four of the input data 201 are identical to the four password data 103 that are pre-stored in the smart card (1), as shown in FIG. 8, the processing module 21 of the cellphone (2) transmits the verification-successful information 104 to the cellphone (2). When the processing module 21 of the cellphone (2) receives the verification-successful information 104, the processing module 21 can control the touchscreen 22 to present corresponding notification information, e.g., “Verification successful! Transaction in progress.” Afterwards, the processing module 21 of the cellphone (2) can be linked to a remote bank server and proceed with the transaction. It should be noted that, after the processing module 21 of the cellphone (2) receives the verification-successful information 104, the operation to be proceeded by the processing module 21 can be varied depending on practical requirements, and the present disclosure is not limited thereto.

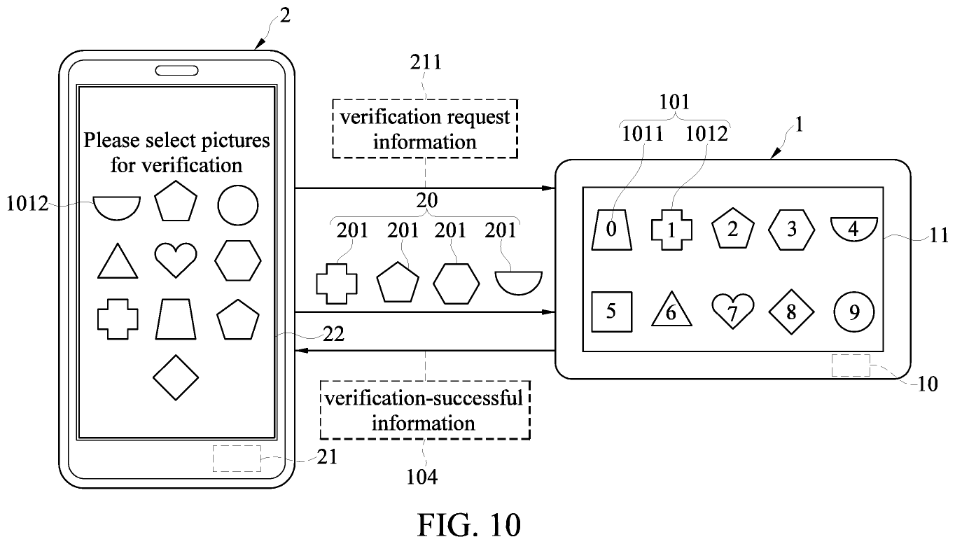

As shown in FIG. 6, FIG. 7 and FIG. 9, assuming that the user sequentially clicks on the rectangle picture, the triangle picture, the heart-shaped picture and the rhombus picture after the touchscreen 22 of the cellphone (2) presents the ten pictures, the processing module 10 of the smart card (1) receives the four of the input data 201 transmitted by the cellphone (2) and then converts the four of the input data 201 into Arabic numerals, 0, 1, 2, and 3, according to the match information 101. The processing module 10 of the smart card (1) then determines that the four to-be-verified passwords, 0, 1, 2, and 3, are not identical to the four password data, 1, 2, 3, and 4, that are pre-stored in the smart card (1). After that, the smart card (1) transmits the verification-failed information 105 to the cellphone (2). When the processing module 21 of the cellphone (2) receives the verification-failed information 105, corresponding notification information (e.g., “Verification failed.”) can then be presented on the touchscreen 22.

In practice, when the processing module 21 of the cellphone (2) receives the verification-failed information 105, the processing module 21 of the cellphone (2) can determine, at that specific time, a number of times the verification-failed information 105 is received in a predetermined period of time, such as ten minutes. When the processing module 21 of the cellphone (2) determines that the number of times the verification-failed information 105 received within the predetermined period of time has exceeded a predetermined number, the processing module 21 of the cellphone (2) can control the touchscreen 22 to present corresponding warning information, e.g., “Verification failed more than three times! Please contact the bank.”, with the user being prohibited from utilizing the cellphone (2) to transmit the afore-mentioned verification request information 211 to the smart card (1).

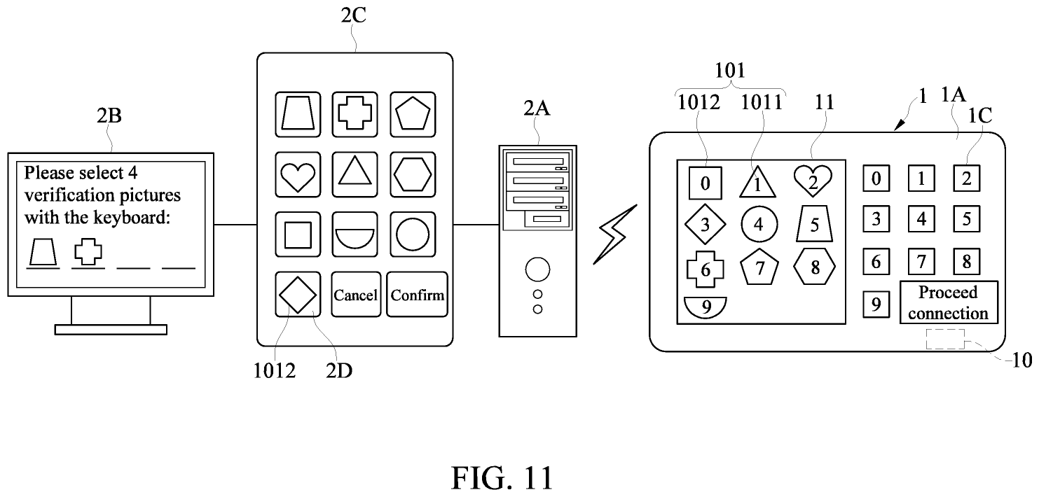

As shown in FIG. 10, when the processing module 21 of the cellphone (2) determines that the number of the verification-failed information 105 received has not exceeded the predetermined number, the processing module 21 of the cellphone (2) can once again transmit the verification request information 211 to the smart card (1). When the smart card (1) again receives the verification request information 211, the smart card (1) can generate a new set of the match information 101, such that the user can see, from the display unit 11 of the smart card (1), not-entirely-identical one-to-one substitution relations of each of the ten Arabic numerals and each of the ten pictures. That is to say, from the display unit 11 of the smart card (1), the user can see that the Arabic numerals, 0, 1, 2, 3, 4, 5, 6, 7, 8, and 9, respectively have the one-to-one substitution relations with the trapezoid picture, the cross-shaped picture, the pentagon picture, the hexagon picture, the semicircle picture, the rectangle picture, the triangle picture, the heart-shaped picture, the rhombus picture, and the circle picture.

As mentioned above, when the display unit 11 of the smart card (1) is presenting the match information 101, the user is able to see the ten identical pictures on the cellphone (2) simultaneously, and the user can, through seeing which four pictures are respectively corresponding to the Arabic numerals, 1, 2, 3, and 4, sequentially click on the cross-shaped picture, the pentagon picture, the hexagon picture, and the semicircle picture on the touchscreen 22 of the cellphone (2). After that, the cellphone (2) transmits the input information 20 including the four of the input data 201 to the smart card (1). The smart card (1) receives the input information 20 transmitted from the cellphone (2), and converts the four of the input data 201 into four of the to-be-verified password data 102, which are the Arabic numerals, 1, 2, 3, and 4, according to the match information 101. After that, the smart card (1) determines that four of the to-be-verified password data 102 are identical to four of the password data, 1, 2, 3, and 4, and then the smart card (1) transmits the verification-successful information 104 to the cellphone (2).

It is worth mentioning that, as shown in FIG. 7 and FIG. 10, in practice, each time the unsecure device 2 presents P of the second verification data 1012, the position where P of the second verification data 1012 are presented on the display unit of the unsecure device 2 (such as a touchscreen) can be not entirely identical.

According to the above, when the verification method of the present disclosure is applied to the cellphone (2) and the smart card (1), under a circumstance that the smart card (1) and the cellphone (2) are not acquired by an unauthorized third party at the same time, it is not possible to directly utilize the cellphone (2) to operate verifications that are required to be done with the smart card (1). Even if an unauthorized third party has acquired both of the smart card (1) and the cellphone (2), since the password that is pre-stored in the smart card (1) is not directly presented in any of the steps operated in the smart card (1) and the cellphone (2), the unauthorized third party is not able to figure out which pictures are to be selected on the cellphone (2), when the cellphone (2) and the smart card (1) respectively present P of the second verification data 1012 and the match information 101. Moreover, even if an unauthorized third party does see the pictures which are selected by the user on the cellphone (2) during the process of verification by the smart card (1), since the one-to-one substitution relations between each of N of the first verification data 1011 and each of N of the second verification data 1012 are not entirely identical each time the smart card (1) generates the match information 101, the unauthorized third party is not able to pass the verification by selecting on the cellphone (2) the pictures which he/she learned from peeking.

The above description is described from the perspective of the user operating the cellphone (2) and the smart card (1), and the following is described from another perspective, which is computer programing. The storing unit 12 of the secure device 1 can store N integers (first verification data 1011) in a form of a one-dimensional array. Each time the processing module 10 generates the match information 101, random numbers are used to generate N of the integers, and then N of the integers are stored in the one-dimensional array, so as to renew all elements in the one-dimensional array. Each of the unsecure devices 2 can, according to the operation of the user, determine which of the second verification data 1012 are selected by the user, and generate M of the corresponding input data 201. Each of the input data 201 can be corresponding to the indexes of the one-dimensional array. In the afore-mentioned step S121, after the processing module 10 of the secure device 1 receives M of the indexes (the input data 201), according to M of the indexes, the processing module 10 reads the corresponding integers from the one-dimensional array, and complete the step of substituting the first verification data 1011 for the input data 201 accordingly. In short, when the user sequentially selects four of the pictures presented on the touchscreen 22 of the cellphone (2), the cellphone (2) generates four of the indexes, and the cellphone (2) then transmits four of the indexes to the smart card (1). After the smart card (1) receives four of the indexes, the smart card (1) extracts the corresponding elements that are stored in the one-dimensional array according to four of the indexes, and four of the extracted elements are the afore-mentioned to-be-verified password.

It should be noted that, in the embodiment in which the user proceeds with the password pre-storing step on the secure device 1 through the unsecure device 2, the user is able to execute a password setting process through an application on the unsecure device 2. When the unsecure device 2 executes the password setting process, the unsecure device 2 is first connected to the secure device 1 wirelessly, e.g., through Bluetooth®. After the secure device 1 and the unsecure device 2 are wirelessly connected, the unsecure device 2 can transmit a password setting request information, e.g., information including the brand, model, instructions for password setting of the unsecure device 2, etc. to the secure device 1. When the secure device 1 receives the password setting request information, the secure device 1 determines whether or not the unsecure device 2 is a device that has passed the verification, e.g., a device that has been paired previously through Bluetooth®, and the processing module of the secure device 1 determines that the status of the secure device 1 for the time being can proceed with password setting, e.g., a status in which the secure device 1 has never set a password, or a status in which the secure device 1 is forced to reset the password, the display unit of the secure device 1 then presents the match information 101, and the secure device 1 then responds the response information to the unsecure device 2; then, after the unsecure device 2 receives the response information, the processing module of the unsecure device 2 controls the display unit of the unsecure device 2 to present the second verification data 1012. After that, the user can select the second verification data 1012 in the unsecure device 2 through seeing the one-to-one substitution relations of each of the first verification data 1011 and each of the second verification data 1012 in the match information 101 presented by the secure device 1, such that the unsecure device 2 correspondingly generates to-be-set password data. After the secure device 1 receives the to-be-set password data from the unsecure device 2, the secure device 1, according to the match information 101, converts the to-be-set password data into the first verification data 1011. The secure device 1 then stores the converted first verification data 1011 as the afore-mentioned password data 103 in the storing unit 12 of the secure device 1. More specifically speaking, as shown in FIG. 7, when the secure device 1 determines that a password can be set for the time being, and when the secure device 1 determines that the unsecure device 2 requesting for the password setting is a device that has passed the verification, the unsecure device 2 presents the second verification data 1012, and the secure device 1 presents the match information 101. Assuming that the user is to set 1, 2, 3, and 4 as the password of the secure device 1, the user can sequentially select the triangle picture, the heart-shaped picture, the rhombus picture, and the circle picture, which are presented on the unsecure device 2, and the unsecure device 2 then generates the to-be-set password data correspondingly. After the secure device 1 receives the to-be-set password data transmitted by the unsecure device 2, the secure device 1, according to the match information 101, converts the to-be-set password data into 1, 2, 3, and 4, which are stored in the storing unit 12 of the secure device 1 as the afore-mentioned password data 103.

As mentioned above, it should be noted that when the secure device 1 receives the password setting request information transmitted by the unsecure device 2 and determines that the unsecure device 2 is not a device that has passed the verification, e.g., the secure device 1 has never been paired with the unsecure device 2 successfully through Bluetooth®, or when the secure device determines that the password cannot be set for the time being, the secure device 1 can then transmit a refusal information to the unsecure device 2, such that the unsecure device 2 cannot proceed with the password setting to the secure device 1. After that, the user can see a related notification information, e.g., “This device is not a verified device. Cannot proceed with password setting.”, is presented on at least one of the display unit of the secure device 1 or the display unit of the unsecure device 2.

Through the above mentioned method of setting a password for the secure device 1, the secure device 1 can be without an input unit. Since the to-be-set password data transmitted by the unsecure device 2 is not in plain text, the password set by the user cannot be cracked, even if an unauthorized third party has acquired the to-be-set password data.

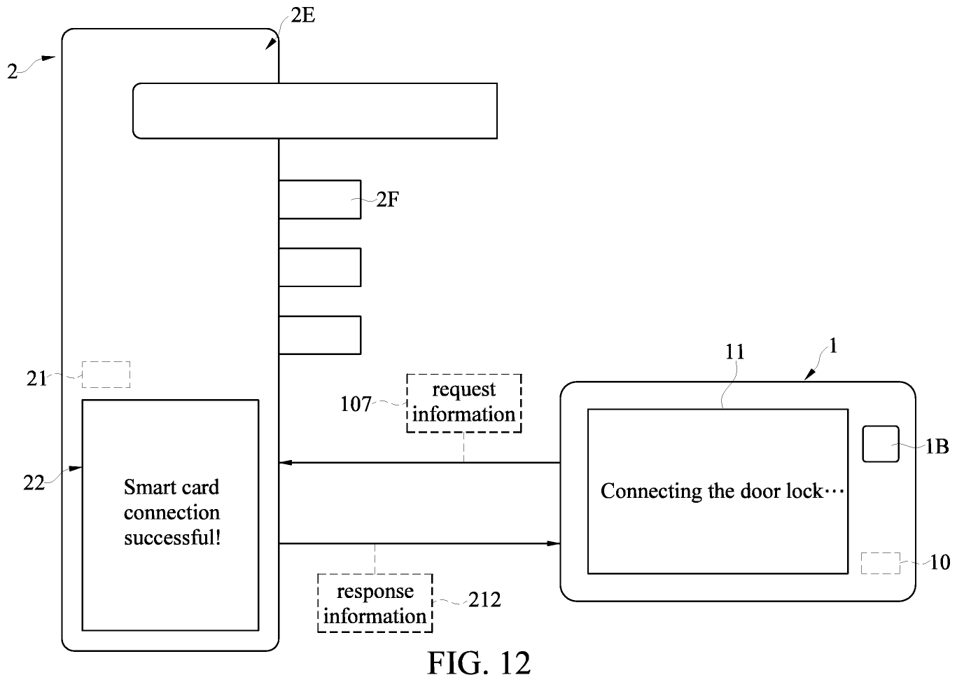

Reference is made to FIG. 11, which is the schematic view of the verification method that is executed by the smart card (the secure device) and computer device (the unsecure device) of the present disclosure. The unsecure device 2 can include a computer 2A (which is the processing module 21), a screen 2B (which is the display unit of the touchscreen 22), and a keyboard 2C (which is the input unit of the touchscreen 22). The keyboard 2C includes N of buttons 2D, and each of N of the buttons 2D has pictures that corresponds to N of the second verification data 1012 presented on the display unit 11. Specifically speaking, the keyboard 2C has twelve of the buttons 2D, and ten of the buttons 2D have the trapezoid picture, the cross-shaped picture, the pentagon picture, the heart-shaped picture, the triangle picture, the hexagon picture, the rectangle picture, the semicircle picture, the circle picture, and the rhombus picture correspondingly.

The smart card (1) can include the body 1A, the display unit 11, and ten of operating buttons 1C, and surfaces of ten of the operating buttons 1C presents Arabic numerals 0 to 9 correspondingly. The user can set the password data that is stored in the smart card (1) through pressing the operating buttons 1C. The processing module 10 of the smart card (1) can be wirelessly connected to the computer 2A.

When the display unit 11 of the smart card (1) presents the match information 101 and the user sees the one-to-one substitution relations of each of the ten Arabic numerals and each of the ten pictures from the display unit 11, the computer 2A can control the screen 2B to present related notification information, e.g., “Please select 4 verification pictures with the keyboard.”, so as to notify the user to select four of the pictures from the keyboard 2C that corresponds to the password data that are pre-stored in the smart card (1). To be more specific, when four of the password data that are pre-stored by the user in the smart card (1) are 5, 6, 7, and 8, under the circumstance shown in FIG. 11, the user can press the buttons 2D having the trapezoid picture, the cross-shaped picture, the pentagon picture, and the hexagon picture sequentially.

In practice, when the user press a certain button of the smart card (1), e.g., a “Proceed connection” button shown in FIG. 11, the processing module 10 of the smart card (1) transmits the afore-mentioned request information to the computer 2A. After the computer 2A receives the request information and responds with the corresponding respond information, the smart card (1) can then execute the verification code presenting step S10. Conversely, the processing module 10 of the smart card (1) can control the display unit 11 to present notification information indicating “Connection failed.”, etc.

In a different embodiment, the computer 2A can also transmit a connection request information to the smart card (1). When the smart card (1) receives the connection request information and verifies that the connection request information is transmitted from a device that has passed the verification, the smart card (1) can execute the verification code presenting step S10. When the smart card (1) determines that the connection request information is transmitted from a device that has not passed the verification, the smart card (1) does not execute the verification code presenting step S10. For example, when the user brings the smart card (1) to a bank to proceed with a transaction, a staff of the bank can transmit the connection information to the smart card (1) through a computer of the bank. When the smart card (1) determines that the connection request information is transmitted by the computer of the certain bank, the smart card (1) controls the display unit 11 to present the match information 101; otherwise the smart card (1) does not control the display unit 11 to present the match information 101.

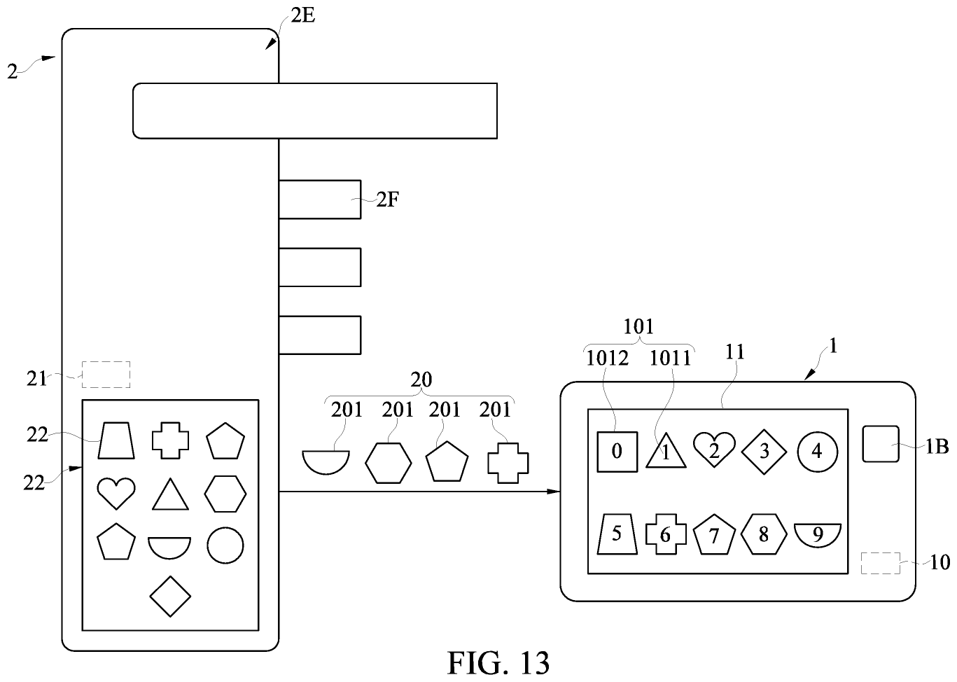

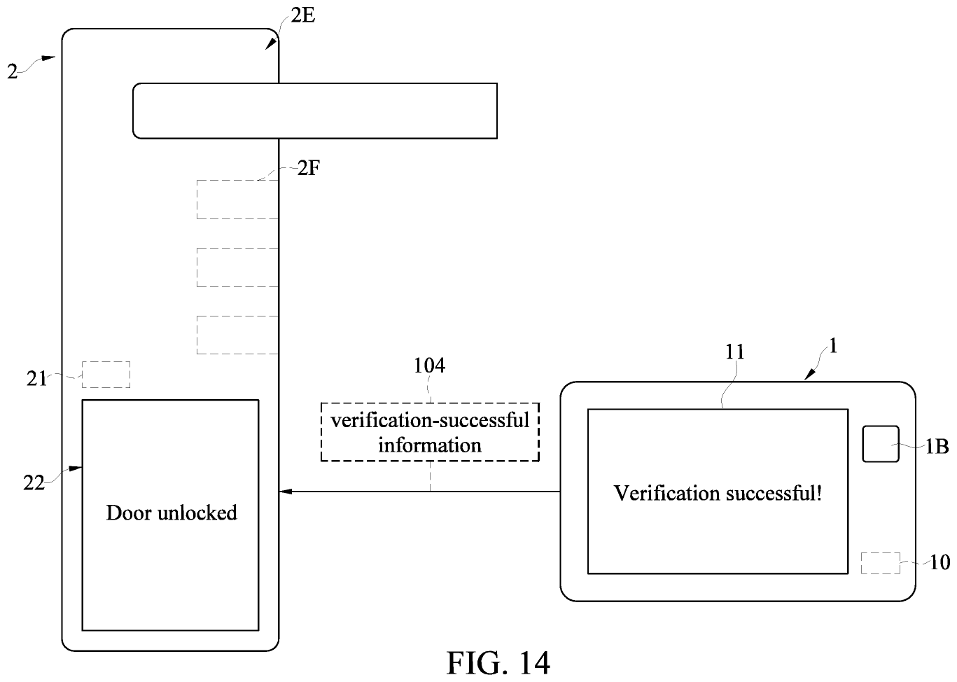

References are made to FIG. 12 and FIG. 13, which are respectively one of the schematic views of the process of the first embodiment of the verification method that is executed by the smart card (the secure device) and an electronic door lock (an unsecure device) of the present disclosure. In this embodiment, examples are made in which the secure device is the smart card and the unsecure device is the electronic door lock. Moreover, in order to more clearly and concisely indicate that the smart card is the secure device 1 and the electronic door lock is the unsecure device 2, descriptions in the following are presented as smart card (1) and electronic door lock (2).

As shown in FIG. 12, the smart card (1) can include an activating button 1B, and the activating button 1B is electrically connected to the processing module 10. The electronic door lock (2) includes a door lock body 2E, the processing module 21, the touchscreen 22, and a door blot assembly 2F. The processing module 21 of the electronic door lock (2) is electrically connected to the touchscreen 22, and can control the touchscreen 22. In addition, the processing module 21 of the electronic door lock (2) can control an actuation of the door bolt assembly 2F, so as to have the door bolt assembly 2F protrude out of the door lock body 2E to lock a door, or to have the door bolt assembly 2F retract in the door lock body 2E to unlock the door.

When the user is to unlock the electronic door lock (2) with the smart card (1), the user can press the activating button 1B of the smart card (1). When the processing module 10 of the smart card (1) detects that the activating button 1B is being pressed, the processing module 10 generates and transmits a request information 107 to the processing module 21 of the electronic door lock (2). After the processing module 21 of the electronic door lock (2) receives the request information 107, the processing module 21 of the electronic door lock (2) can first verify whether or not the user information included in the request information 107 is correct, e.g., a serial number of the smart card (1). When the processing module 21 of the electronic door lock (2) determines that the user information in the request information 107 is correct, the processing module 21 of the electronic door lock (2) then responds a response information 212 to the smart card (1).

As shown in FIG. 12 and FIG. 13, when the processing module 21 of the electronic door lock (2) responds the response information 212 to the smart card (1), the processing module 21 of the electronic door lock (2) then controls the touchscreen 22 to present the ten pictures that are different from one another (P of the afore-mentioned second verification data 1012). The smart card (1) executes the verification code presenting step S10 after receiving the response information 212, and the display unit 11 of the smart card (1) presents the match information 101. At this time, the user can see that ten of the Arabic numerals that are different from one another (N of the afore-mentioned second verification data 1012) and ten of the pictures that are different from one another (P of the afore-mentioned second verification data 1012) are presented on the display unit 11 of the smart card (1). Moreover, on the display unit 11 of the smart card (1), the user can see that the Arabic numerals, 0, 1, 2, 3, 4, 5, 6, 7, 8, and 9, have the one-to-one substitution relations respectively with the rectangle picture, the triangle picture, the heart-shaped picture, the rhombus picture, the circle picture, the trapezoid picture, the cross-shaped picture, the pentagon picture, the hexagon picture, and the semicircle picture.

When the display unit 11 of the smart card (1) presents ten of the Arabic numerals that are different from one another and ten of the pictures that are different from one another, the user can, according to the match information 101, determine four of the pictures that corresponds to four password information that are pre-stored in the smart card (1). For example, assuming that the four password information pre-stored in the smart card (1) by the user are 9, 8, 7 and 6, the user is able to, through seeing the match information 101 of the smart card (1), know that the four password information respectively correspond to the semicircle picture, the hexagon picture, the pentagon picture, and the cross-shaped picture. After that, the user can sequentially select the semicircle picture, the hexagon picture, the pentagon picture, and the cross-shaped picture on the touchscreen 22 of the electronic door lock (2).

When the user sequentially selects on the touchscreen 22 of the electronic door lock (2) M of the pictures, which are corresponding to M of the password information that are pre-stored in the smart card (1), the processing module 21 of the electronic door lock (2) generates the input information 20 including M of the input data 201 correspondingly, and the electronic door lock (2) transmits the input information 20 to the smart card (1). After the smart card (1) receives the input information 20, the smart card (1) converts M of the input data 201 included in the input information 20 into M of the first verification data 1011 (the to-be-verified password data 102) according to the match information 101, and determines whether or not M of the first verification data 1011 are identical to M of the password data 103 that are pre-stored in the smart card (1).

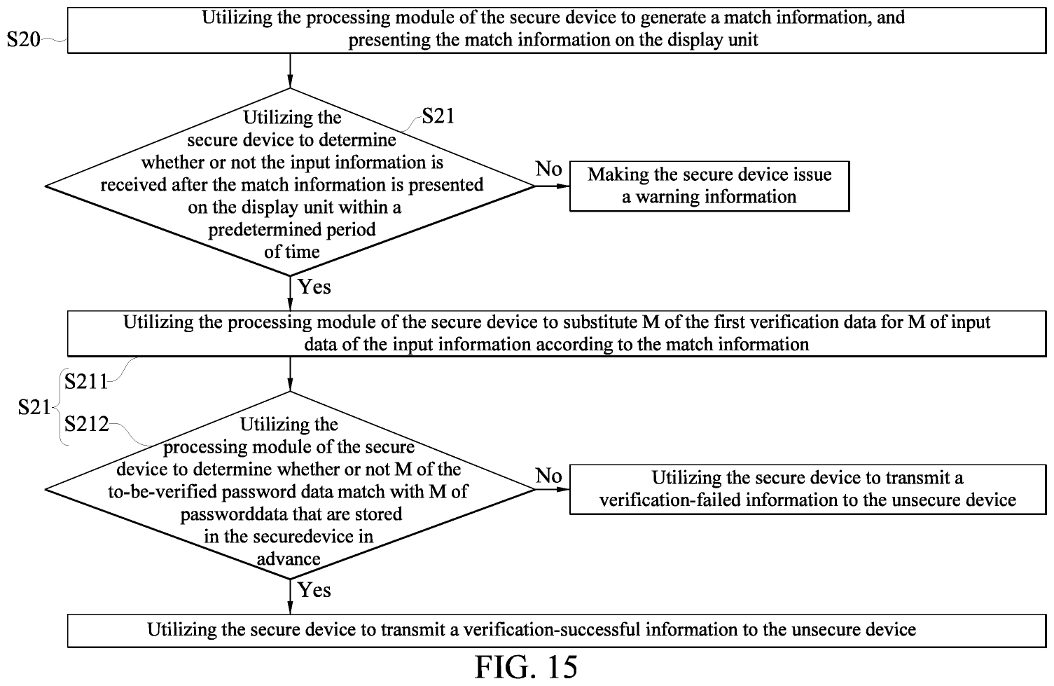

As shown in FIG. 14, when the processing module 10 of the smart card (1) determines that M of the first verification data 1011 are identical to M of the password data 103 that are pre-stored in the smart card (1), the processing module 10 of the smart card (1) transmits the verification-successful information 104 to the electronic door lock (2), After the processing module 21 of the electronic door lock (2) receives the verification-successful information 104, the electronic door lock (2) controls the door bolt assembly 2F to actuate, such that the door bolt assembly 2F is not locked to a doorframe, thus allowing the door to be opened. In the afore-mentioned process, the processing module 10 of the smart card (1) and the processing module 21 of the electronic door lock (2) can respectively control the display unit 11 and the touchscreen 22 to present corresponding notification information, e.g., “Verification successful! Door unlocked.”, so as to notify the user that the verification of the smart card (1) is completed and the door is unlocked.

Conversely, when the smart card (1) determines that the to-be-verified password data 102 are not identical to M of the password data 103 that are pre-stored in the smart card (1), the processing module 10 of the smart card (1) transmits the verification-failed information 105 to the electronic door lock (2). After the processing module 21 of the electronic door lock (2) receives the verification-failed information 105, the electronic door lock (2) does not control the door bolt assembly 2F to actuate. Further, the electronic door lock (2) can control the touchscreen 22 to present corresponding notification information, so as to notify the user that the verification of the smart card (1) has failed.

According to the above, when the verification method provided by the present disclosure is applied to the electronic door lock (2), since the electronic door lock (2) not stored with any password information, and the electronic door lock (2) only presents ten of the pictures after receiving the request information 107 from the smart card (1), thus making the electronic door lock (2) difficult to be cracked. Moreover, even if an unauthorized third party has stolen the smart card (1) and successfully made ten of the pictures be presented on the touchscreen 22, since the smart card (1) only presents the one-to-one substitution relation between each of the ten Arabic numerals and each of the ten pictures and since the smart card (1) does not present the password that is pre-stored in the smart card (1) directly, the unauthorized third party is still not able to figure out which of the pictures to select on the touchscreen 22 of the electronic door lock (2).

Even if the unauthorized third party does see the pictures which are selected by the user on the touchscreen 22 of the electronic door lock (2) and has also acquired the smart card (1), since the smart card (1) does not directly present the password that is pre-stored in the smart card (1), and since the one-to-one substitution relations between each of the ten Arabic numerals and each of the ten pictures are not entirely identical each time the one-to-one substitution relations are generated by the smart card (1), the unauthorized third party is still not able to pass the verification by selecting the pictures which he/she previously saw, to unlock the electronic door lock (2). It is worth mentioning that the electronic door lock (2) can be applied to a door for people to pass through, a safe, etc.

In the above description, the electronic door lock (2) of this embodiment is exemplified as having the touchscreen 22, but in a different embodiment, the electronic door lock (2) can have a screen without a touchscreen function and a plurality of physical buttons. Furthermore, this embodiment takes the example of the secure device 1 being the smart card, but in a different embodiment, the secure device 1 can also be smartphones, smart watches, etc.

In a different embodiment, the electronic door lock (2) can, according to the operation of the user, search the perimeter to find if there is the smart card (1). The electronic door lock (2) can, after detecting the smart card (1), be transmitting related confirmation information to the smart card (1) firstly. After the smart card (1) receives the related confirmation information transmitted by the electronic door lock (2), the smart card (1) can first determine whether or not the confirmation information is transmitted from a device that has passed the verification. When the smart card (1) determines that the confirmation information is transmitted from a device that has passed the verification, the smart card (1) can respond with related information, and execute the verification code presenting step S10.

### Second Embodiment

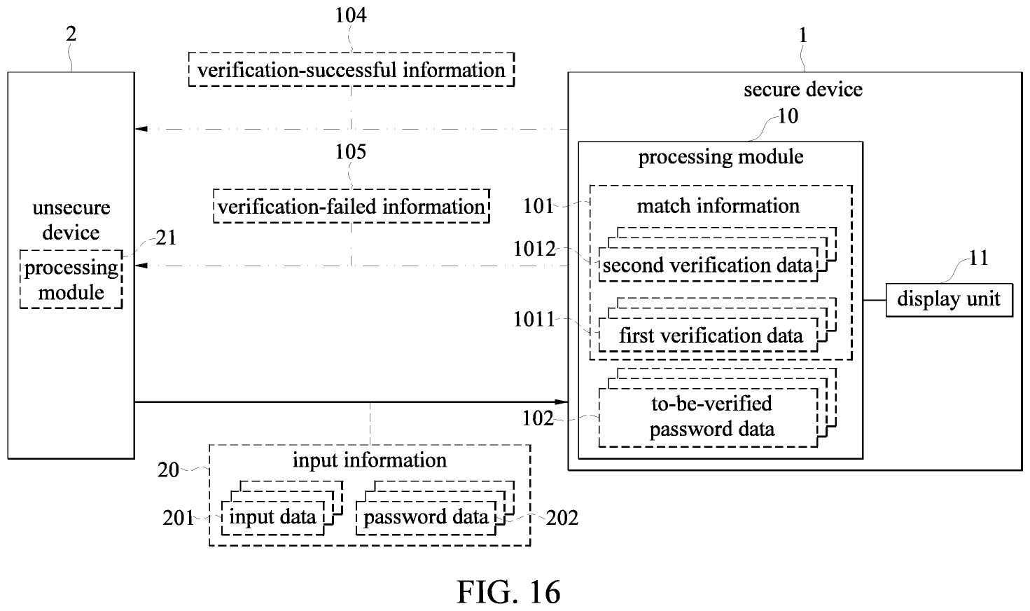

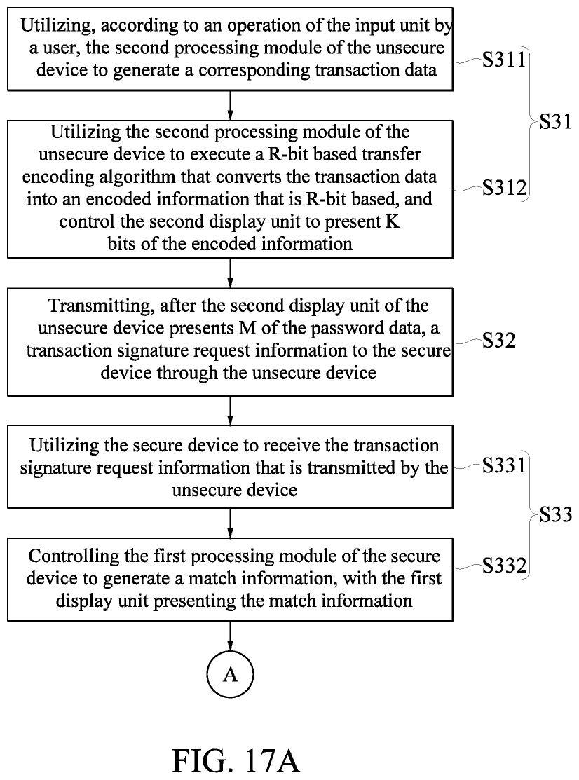

References are made to FIG. 15 and FIG. 16. FIG. 15 is a flowchart of a verification method in a second embodiment of the present disclosure. FIG. 16 is a block diagram of the secure device and the unsecure device in the verification method in the second embodiment of the present disclosure. The verification method includes:

A verification code presenting step S20:
utilizing the processing module 10 of the secure device 1 to generate a match information 101, the match information 101 being presented on the display unit 11, with the match information 101 including N of first verification data 1011 that are different from one another and N of second verification data 1012 that are different from one another, one-to-one substitution relations between each of N of the first verification data 1011 and each of N of the second verification data 1012 being presented on the display unit 11 by the match information 101, and the one-to-one substitution relations between each of N of the first verification data 1011 and each of N of the second verification data 1012 being not entirely identical each time the one-to-one substitution relations are generated by the processing module 10;

executing, when the secure device 1 receives an input information 20 within a predetermined period of time after the display unit 11 presents the match information 101, the following steps:

a verification step S21, including:

Step S211: utilizing the processing module 10 of the secure device 1 to substitute M of the first verification data 1011 for M of input data 201 of the input information 20 according to the match information 101, with the processing module 10 defining M of the first verification data 1011 generated through the substitution as M of to-be-verified password data 102 according to the match information 101, the unsecure device 2 being capable of presenting P of the second verification data 1012, and the unsecure device 2, according to an operation of the user, can determine which of the second verification data 1012 are selected by the user, and generating M of the corresponding input data 201, with N being a positive integer greater than 1, and M being a positive integer;

Step S212: utilizing the processing module 10 of the secure device 1 to determine whether or not M of the to-be-verified password data 102 match with M of password data 202 that are included in the input information 20;

When the processing module 10 of the secure device 1 determines that M of the to-be-verified password data 102 match with M of the password data 202, the secure device 1 transmits a verification-successful information 104 to the unsecure device 2.

When the processing module 10 of the secure device 1 determines that M of the to-be-verified password data 102 do not match with M of the password data 202, the secure device 1 transmits a verification-failed information 105 to the unsecure device 2.

The most significant difference between the verification method provided in this embodiment and the verification in the first embodiment of the present disclosure is that, in addition to M of the input data 201, the input information 20 transmitted by the unsecure device 2 further includes M of the password data 202. After the secure device 1 receives the input information 20, the secure device 1 divides the input information 20 into M of the input data 201 and M of the password data 202, according to the match information 101, substitutes M of the input data 201 into M of the first verification data 1011 (which are M of the to-be-verified password data 102), and then determines whether or not M of the first verification data 1011 and the password data 202 match with each other. In other words, in the verification method in the first embodiment of the present disclosure, M of the password data 103 is stored in the smart card (1), but in the verification method in the second embodiment of the present disclosure, M of the password data 202 are transmitted along with the input data 201 from the unsecure device 2 to the secure device 1.

In practice, M of the password data 202 and M of the input data 201 can be a part of the input information 20 through cascading in a certain method or a certain form. After the secure device 1 receives the input information 20, the secure device 1 first utilizes the certain method to analyze M of the password data 202 and M of the input data 201 from the input information 20. That is to say, even if the unauthorized third party has acquired the input information 20, he/she cannot figure out the corresponding relations between M of the password data 202 and M of the input data 201 in the input information 20. It is worth mentioning that the implementations that are mentioned in the previous embodiments can all be adjusted according to practical requirements and be applied in this embodiment, and will not be reiterated herein.

In practice, in the verification step S21, before the processing module 10 of the secure device 1 substitutes M of the first verification data 1011 for M of the input data 201, a presenting step can be further included: utilizing a display unit of the unsecure device 2 to present P of the second verification data 1012 and K of encoded data, such as a 16-bit based character string, and utilizing the processing module 21 of the unsecure device 2 to determine which of the second verification data 1012 are selected by the user, so as to generate M of the input data 201 correspondingly, M of K of the encoded data are defined as password data, and K is a positive integer greater than or equal to M. For example, assuming that M is 5 and K is 8, in the presenting step, the user can see sixteen pictures (sixteen of the second verification data 1012) and “18635a1e” (eight of the encoded data) on the display unit of the unsecure device 2. At this time, according to the match information 101 presented by the secure device 1, the user can select five of the pictures that correspond to “35a1e” on the display unit of the unsecure device 2. Therefore, the unsecure device 2 is to generate five of the input data 201, and the input data 20, which is transmitted from the unsecure device 2 to the secure device 1, includes five of the input data 201 and “35a1e” (five of the eight encoded data).

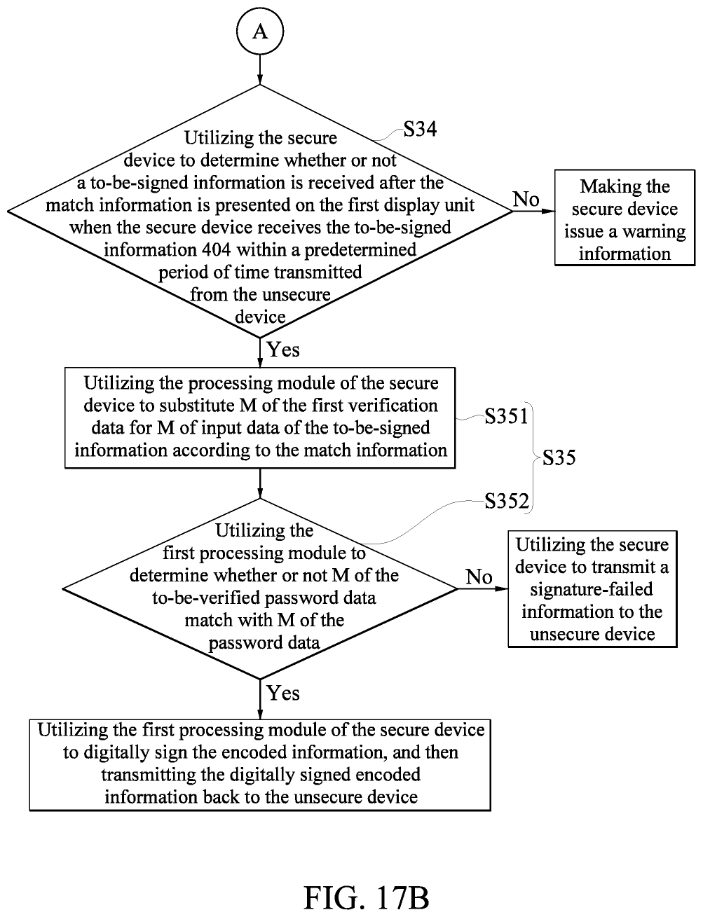

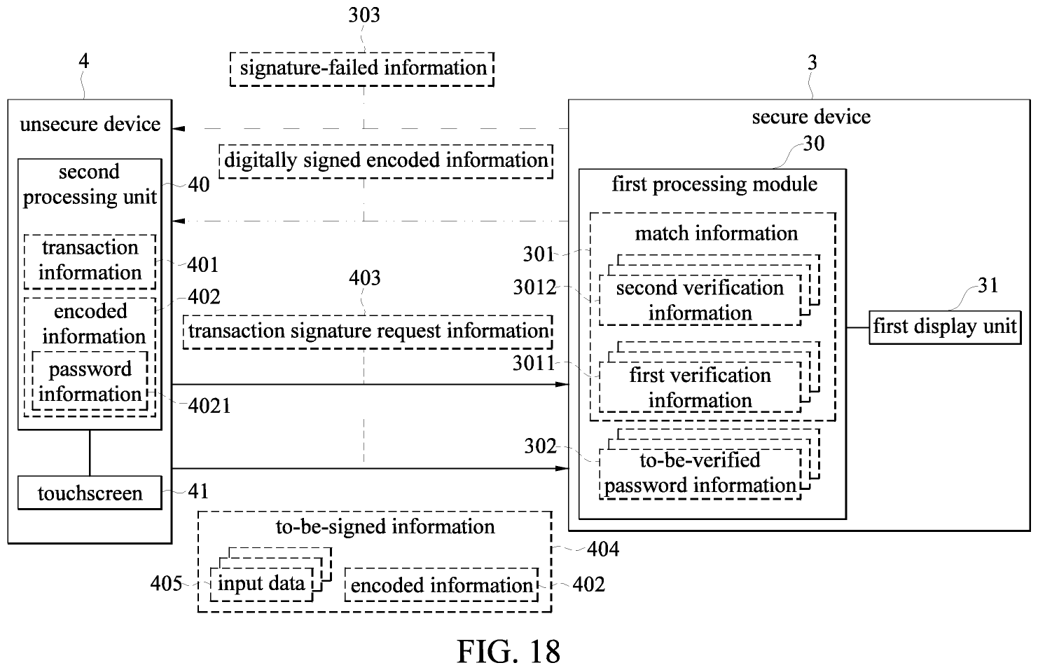

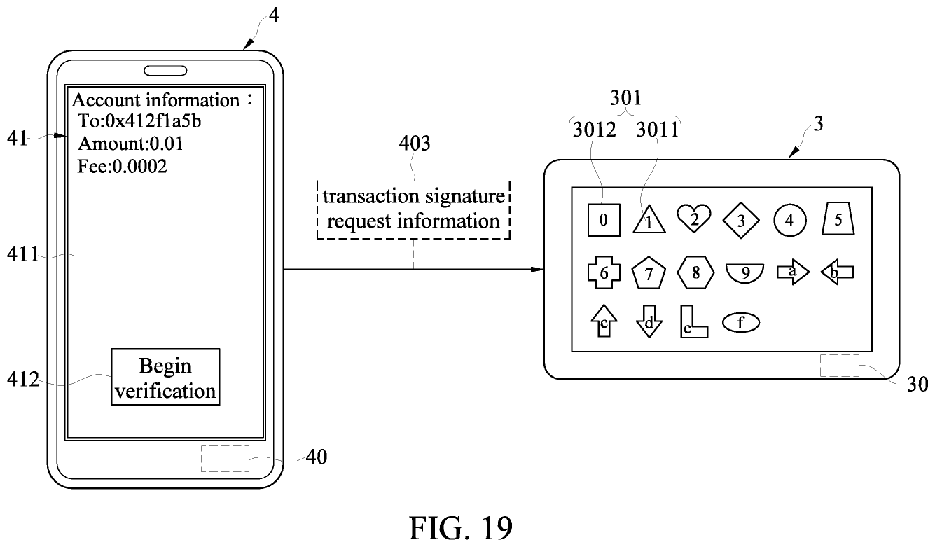

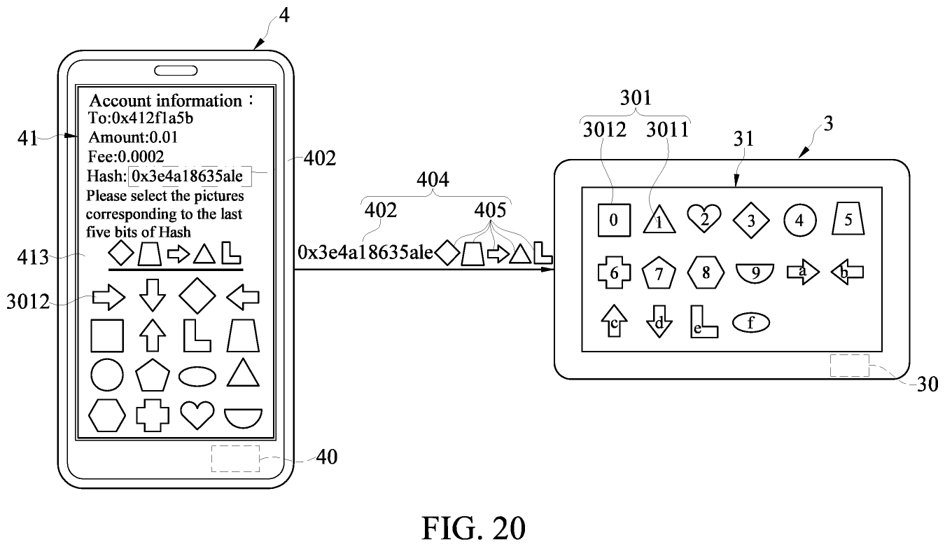

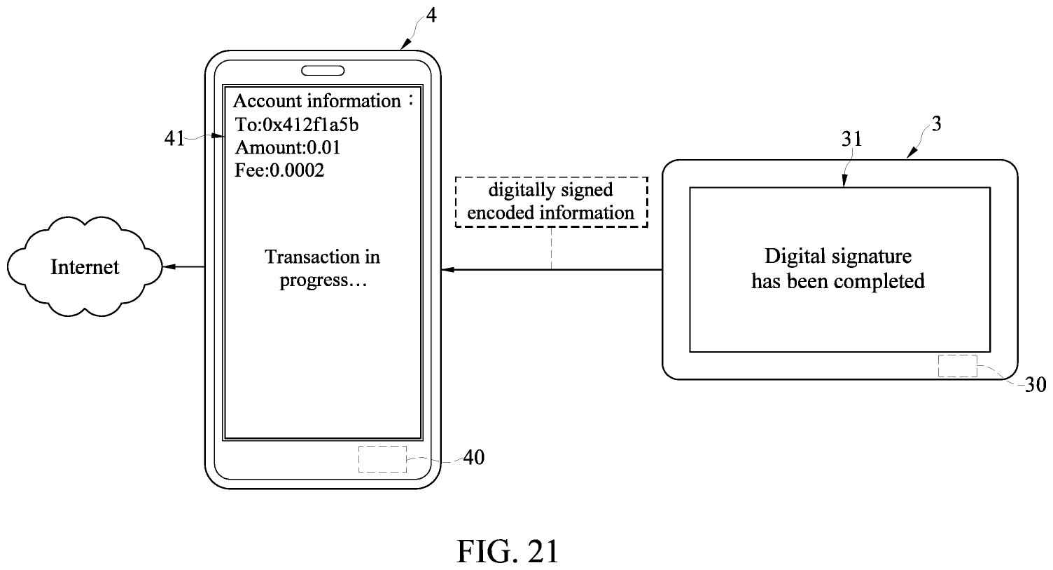

References are made to FIG. 17A and FIG. 17B to FIG. 21. FIG. 17A and FIG. 17B are the flowcharts of a transaction verification method of the present disclosure (FIG. 17A and FIG. 17B cooperatively present the flowcharts of the transaction verification method of the present disclosure). FIG. 18 is the block diagram of the secure device and the unsecure device in the transaction verification method of the present disclosure. FIG. 19, FIG. 20 and FIG. 21 are the schematic views of the transaction verification method of the present disclosure. The transaction verification method of the present disclosure is applicable for a secure device 3 and an unsecure device 4. The secure device 3 includes a first processing module 30 and a first display unit 31, and the unsecure device 4 includes a second processing module 40 and a touchscreen 41 (which integrates a second display unit and an input unit). The transaction verification method including:

a transaction information inputting step S31:
Step S311: utilizing, according to an operation of the touchscreen 41 (the input unit) by a user, the second processing module 40 of the unsecure device 4 to generate a corresponding transaction data 401;
Step S312: utilizing the second processing module 40 of the unsecure device 4 to execute a R-bit based transfer encoding algorithm that converts the transaction data 401 into an encoded information 402 that is R-bit based, and control the touchscreen 41 (including the second display unit and the input unit) to present K characters of the encoded information 402, with R being a positive integer greater than 1, M characters of the encoded information 402 presented by the touchscreen 41 (including the second display unit and the input unit) being defined as M of password data 4021, and K being a positive integer greater than or equal to M;
a transaction signature request information step S32:

transmitting, after the touchscreen 41 (including the second display unit and the input unit) of the unsecure device 4 presents M of the password data 4021, a transaction signature request information 403 to the secure device 3 through the unsecure device 4;

a transaction verification code presenting step S33:
Step S331: utilizing the secure device 3 to receive the transaction signature request information 403 that is transmitted by the unsecure device 4; Step S332: controlling the first processing module 30 of the secure device 3 to generate a match information 301, with the first display unit 31 presenting the match information 301, the match information 301 including N of first verification data 3011 that are different from one another and N of second verification data 3012 that are different from one another, one-to-one substitution relations between each of N of the first verification data 3011 and each of N of the second verification data 3012 being presented on the first display unit 31 by the match information 301, N being a positive integer that is greater than or equal to 1, M being a positive integer, the one-to-one substitution relations between each of N of the first verification data 3011 and each of N of the second verification data 3012 being not entirely identical each time the one-to-one substitution relations are generated by the first processing module 30; and

a determination step S34:
utilizing the secure device 3 to determine whether or not a to-be-signed information 404 is received after the match information 301 is presented on the first display unit 31, with the input unit (the touchscreen 41) being capable of presenting P of the second verification data 3012, the second processing module 40 of the unsecure device 4 being able to determine which of the second verification data 3012 are selected by the user through the input unit (the touchscreen 41), generating M of input data 405 correspondingly, and the second processing module 40 being able to integrate M of the input data 405 and the encoded information 402 into the to-be-signed information 404;

executing, when the secure device 3 receives the to-be-signed information 404 within a predetermined period of time transmitted from the unsecure device 4, the following steps:

a signature step S35:

Step S351: utilizing the first processing module 30 of the secure device 3, to substitute M of the first verification data 3011 for M of the input data 405 of the to-be-signed information 404 according to the match information 301, with the first processing module 30 defining M of the first verification data 3011 generated through the substitution as M of to-be-verified password data 302 according to the match information 301;

Step S352: utilizing the first processing module 30 to determine whether or not M of the to-be-verified password data 302 match with M of the password data 4021;

when the first processing module 30 of the secure device 3 determines that M of the to-be-verified password data 302 match with M of the password data 4021, the first processing module 30 digitally signs the encoded information 402, and then transmits the digitally signed encoded information 402 back to the unsecure device 4;

when the first processing module 30 of the secure device 3 determines that M of the to-be-verified password data 302 do not match with M of the password data 4021, the first processing module 30 transmits a signature-failed information 303 to the unsecure device 4.

In practice, before the transaction information inputting step S31 or the transaction verification code presenting step S33, a user verification step can be further included: executing the verification method as described in the first embodiment. When the unsecure device 4 receives the verification-successful information from the secure device 3, the unsecure device 4 then executes the transaction information inputting step S31 or the transaction verification code presenting step S33. Conversely, when the unsecure device 4 receives the verification-failed information transmitted from the secure device 3, at least one of the unsecure device 4 or the secure device 3 can present the corresponding notification information, so as to inform the user that the user verification is failed and that the transaction cannot be proceeded.

In practice, in the transaction information inputting step S31, the second processing module 40 of the unsecure device 4 can be utilized to execute a hash algorithm for at least once, and then execute the R-bit based transfer encoding algorithm, such that the transaction data 401 can be converted into the R-bit based encoded information 402. The hash algorithm can be a Secure Hash Algorithm (SHA), such as SHA-2, SHA-3, etc., and MD5 Message-Digest Algorithm, etc., and the present disclosure is not limited thereto. In a preferable application, the second processing module 40 of the unsecure device 4 can utilize the SHA-2 algorithm and the 16-bit based transfer encoding algorithm to convert the transaction data 401 into the encoded information 402. To be specific, the encoded information 402, which is provided through executing the hash algorithm and then converted by executing the R-bit based transfer encoding algorithm, is the message digest of the digital signature.

FIG. 19, FIG. 20 and FIG. 21 are the schematic views of the transaction verification method that is applied to the cellphones and the smart cards in the embodiments of the present disclosure. In the following description, examples are made in which the secure device 3 is a smart card, the unsecure device 4 is a cellphone, K is 5, R is 16, M is 5, N is 16, and P is 16. Moreover, in order to more clearly and concisely indicate that the smart card is the secure device 3 and the cellphone is the unsecure device 4, descriptions in the following are presented as smart card (3) and cellphone (4).

The process that the user proceeds with a transaction utilizing the smart card (3) and the cellphone (4) to execute the transaction verification method of the present disclosure by connecting to the Internet to can be described as the following.

As shown in FIG. 19, first of all, the user uses the cellphone (4) to enter a transaction page 411, e.g., a transfer transaction page, and inputs transaction information through operating the cellphone (4) (the afore-mentioned Step S311); afterwards, the user can select a virtual button 412 of “Begin Verification”, which is presented on the transaction page 411. In practice, the transaction information can include various contents according to different transactions and transaction currencies. For example, when the transaction currency is the local currency and the exchange is a bank, the transaction information can include a transfer-out/transfer-in account number, a transfer-out/transfer-in amount, a handling fee, etc., or, when the transaction currency is cryptocurrency, the transaction information can then include a payment address, a transaction amount, a handling fee, etc.

In practice, the second processing module 40 of the cellphone (4) can execute the verification methods that are described in the afore-mentioned embodiments, before presenting the transaction page 411, such that the user can proceed with the identity verification through the smart card (3) and the cellphone (4). When the user has completed the identity verification through the smart card (3) and the cellphone (4), the second processing module 40 of the cellphone (4) can control the touchscreen 41 (including the second display unit and the input unit) to present the transaction page 411; otherwise, the second processing module 40 of the cellphone (4) can present a warning information, e.g., “Identification verification failed.”.

As shown in FIG. 19 and FIG. 20, when the user selects the virtual button 412 of “Begin Verification” on the touchscreen 41 (including the second display unit and the input unit), the second processing module 40 executes the 16-bit based transfer encoding algorithm with the transaction data 401, so as to convert the transaction data 401 into the 16-bit based encoded information 402; afterwards, the second processing module 40 controls the touchscreen 41 of the cellphone (4) to present the encoded information 402 (the afore-mentioned Step S312) and sixteen pictures that are different from one another (P of the second verification data 3012); subsequently, the second processing module 40 transmits the transaction signature request information 403 to the smart card (3). In a different embodiment, when the user selects the virtual button 412 of “Begin Verification” on the touchscreen 41 (including the second display unit and the input unit), the second processing module 40 can execute the hash algorithm for at least once with the transaction data 401, and then executes the 16-bit based transfer encoding algorithm, so as to convert the transaction data 401 into the 16-bit based encoded information 402.

Plainly speaking, when the user utilizes the cellphone (4) and the smart card (3) to execute the transaction information inputting step S31 and the transaction signature request information step S32, after the user inputs the transfer-out account number, the transfer-out amount, and the transfer-in account number, and presses the virtual button 412 of “Begin verification” presented by the transaction page 411, the second processing module 40 of the cellphone (4) controls the touchscreen 41 to present a verification page 413, and the user can see, in the verification page 413, the last five characters of the converted 16-bit based encoded information 402 (“35a1e”, as shown in FIG. 20), sixteen of the pictures that are different from one another, and the notification information asking the user to select the pictures, e.g., “Please select the pictures corresponding to the last five characters of Hash.”. In a different embodiment, the second processing module 40 can, according to practical requirements, convert the transaction data 401 into 2-bit based, 3-bit based, 6-bit based, and 10-bit based encoded information 402, and the second processing module 40 can control the touchscreen 41 to present the last three characters, the last 4 characters, or the last 6 or more characters of the encoded information 402, and the present disclosure is not limited thereto. It is worth mentioning that each one of the afore-mentioned characters refers to a single English alphabet or a single Arabic numeral that the user sees from the touchscreen 41.

As shown in FIG. 20, after the smart card (3) receives the transaction signature request information 403 transmitted from the cellphone (4) (corresponding to the afore-mentioned Step S331), the first processing module 30 of the smart card (3) generates the match information 301, and the first processing module 30 controls the first display unit 31 to present the match information 301 (corresponding to the afore-mentioned Step S332). The user can see, from the first display unit 31, sixteen character strings, 0, 1, 2, 3, 4, 5, 6, 7, 8, 9, a, b, c, d, e, and f (N of the first verification data), and sixteen of the pictures that are different from one another (N of the second verification data). The user can also see, from the first display unit 31, a one-to-one substitution relation between each of, 0, 1, 2, 3, 4, 5, 6, 7, 8, 9, a, b, c, d, e, and f, and each of a rectangle picture, a triangle picture, a heart-shaped picture, a rhombus picture, a circle picture, a trapezoid picture, a cross-shaped picture, a pentagon picture, a hexagon picture, a semicircle picture, a rightward arrow picture, a leftward arrow picture, an upward arrow picture, a downward arrow picture, an L-shaped picture, and an oval picture, respectively.

As described in the afore-mentioned embodiment, at this time, the user can sequentially select the pictures corresponding to the last five characters of the encoded information 402, after seeing the substitution relations presented by the smart card (3) between the sixteen character strings and the sixteen pictures that are different from one another. That is to say, under the circumstance shown in FIG. 18, the user can figure out, from the smart card (3), that the last five characters of the encoded information 402, i.e., “35a1e”, respectively correspond to the rhombus picture, the trapezoid picture, the rightward arrow picture, the triangle picture and the L-shaped picture.

Afterwards, when the user sequentially selects the rhombus picture, the trapezoid picture, the rightward arrow picture, the triangle picture and the L-shaped picture on the touchscreen 41 of the cellphone (4), the second processing module 40 generates five of the corresponding input data 405; sequentially, the second processing module 40 packs the encoded information 402 and five of the input data 405 into the to-be-signed information 404, and transmits the to-be-signed information 404 to the smart card (3) (the afore-mentioned Step S341).

After the first processing module 30 of the smart card (3) receives the to-be-signed information 404, the first processing module 30 of the smart card (3), according to the match information 301, substitutes five of the input data 405 (the rhombus picture, the trapezoid picture, the rightward arrow picture, the triangle picture and the L-shaped picture) with five of the to-be-verified password (“35a1e”). After that, the smart card (3) determines whether or not five of the to-be-determined password match with the character strings corresponding to the last five characters of the encoded information 402 included in the to-be-signed information 404.

The above description is described from the perspective of the user, and the following description is described from the perspective of computer programming: the smart card (3) is stored with a one-dimensional array with a length of sixteen, and when the first processing module 30 of the smart card (3) receives the transaction signature request information 403, the first processing module 30 then randomly stores 0 to 9 and a to f as sixteen of elements in a one-dimensional array. When the user operates the cellphone (4) and sequentially selects five of the pictures on the touchscreen 41, the second processing module 40 of the cellphone (4) generates five of indexes correspondingly, and the second processing module 40 then transmits the encoded information 402 and five of the indexes to the first processing module 30 of the smart card (3). After the first processing module 30 of the smart card (3) receives the encoded information 402 and five of the indexes, the first processing module 30 of the smart card (3), according to the five indexes, extracts five of the corresponding elements from the one-dimensional array (up until here, the first processing module 30 has completed the afore-mentioned Step S342), and determines whether or not five of the elements match with the last five characters of the encoded information 402.

As shown in FIG. 21, when the first processing module 30 determines that five of the elements match with the last five characters of the encoded information 402, the first processing module 30 then digitally signs the encoded information 402. After that, the first processing module 30 transmits the digitally signed encoded information 402 back to the unsecure device 4, and the first processing module 30 can simultaneously control the first display unit 31 to present notification information, e.g., “Digital signature has been completed.”, such that the user is notified that the digital signature is completed by the smart card (3).

More specifically speaking, when the first processing module 30 is digitally signing the encoded information 402, the first processing module 30 is utilizing a private key that is stored in the smart card (3) to proceed with the signing of the encoded information 402, so as to form a signature. After that, the first processing module 30 transmits the signature back to the cellphone (4). After the cellphone (4) receives the signature, the cellphone (4) transmits both the signature and the transaction data 401 to the Internet to proceed with the transaction.

According to the above, through having the to-be-signed information 404 include the encoded information 402 and five of the input data 405, and analyzing the input data 405 of the to-be-signed information 404 so as to be matched with the last five characters of the encoded information 402 before the smart card (3) proceeds with the digital signature, the transaction verification method of the present disclosure is capable of effectively preventing the smart card (3) from digitally signing the to-be-signed information 404 which has been tampered with.

Even if an unauthorized third party executes a MITM attack to acquire the to-be-signed information 404 transmitted from the unsecure device 4 to the secure device 3, and the unauthorized third party understands how to paraphrase the encoded information 402 from the to-be-signed information 404, packs the tampered encoded information 402 and M of the input data 405 into a new to-be-signed information, and transmits the tampered to-be-signed information to the unsecure device 3, after the secure device 3 receives the tampered to-be-signed information, the secure device 3 can then analyze the tampered encoded information and M of the input data 405. Since the encoded information has been tampered, the secure device 3 would determine, according to the match information 301, that the character strings of M of the input data generated through the substitution are not matched with the last M characters of the tampered encoded information. Therefore, the secure device 3 does not digitally sign the tampered to-be-signed information (404).

To be more specific, as shown in FIG. 20, as exemplified above, the last five characters of the encoded information 402 of the to-be-signed information 404 transmitted by the user are 35a1e. Assuming that an unauthorized third party initiates a MITM attack and tampers with the encoded information, since the last five characters of the encoded information are no longer 35a1e, after the secure device 3 receives the tampered to-be-signed information, the secure device 3 would determine that five of the to-be-verified password data (35a1e) is different from the last five characters of the encoded information, and the secure device 3 does not digitally sign the tampered to-be-signed information. Moreover, even if the unauthorized third party realizes, after multiple trials, that M of the input data 405 of the to-be-signed information 404 have to be tampered simultaneously, since the match information 301 generated by the secure device 3 is different each time, the unauthorized third party would not be able to figure out how to tamper with M of the input data 405. According to the above, the transaction verification method of the present disclosure can effectively prevent the MITM attack.

It is worth mentioning that, in the above embodiments, before the secure device and the unsecure device transmit any data and information to each other, an identity verification step can be included. In the identity verification step, the secure device and the unsecure device can both be stored with data that is sufficient to identify each other. When the secure device and the unsecure device are transmitting data and information to each other, the data and the information can include identification information, such as ID numbers, which are sufficient for identifying the device. The secure device and the unsecure device can determine that the data and the information that are being transmitted are from a device that has passed the identity verification through the identification information. When the secure device determines that the unsecure device does not pass the identity verification, it is possible for the secure device to not execute any of the above mentioned steps.

Moreover, the secure devices that are exemplified in the above-mentioned embodiments can preferably be closed devices without Internet connection, and the unsecure device can be open (network connecting) devices that can be connected to the Internet.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A verification method that is applicable for a secure device and an unsecure device, the secure device including a display unit and a processing module, the unsecure device being capable of generating an input information according to an operation of a user, and the processing module of the secure device receiving the input information that is transmitted by the unsecure device, the verification method comprising:
a verification code presenting step:
utilizing the processing module of the secure device to generate a match information, with the display unit presenting the match information; wherein the match information includes N of first verification data that are different from one another and N of second verification data that are different from one another, and one-to-one substitution relations between each of N of the first verification data and each of N of the second verification data are presented on the display unit by the match information; wherein the one-to-one substitution relations between each of N of the first verification data and each of N of the second verification data are not entirely identical each time the one-to-one substitution relations are generated by the processing module; and
executing, when the secure device receives the input information within a predetermined period of time after the match information is presented on the display unit, the following steps:
a verification step:
utilizing the processing module of the secure device to substitute M of the first verification data for M of input data of the input information according to the match information; wherein the processing module defines M of the first verification data generated through the substitution as M of to-be-verified password data according to the match information, the unsecure device presents P of the second verification data, and the unsecure device, according to an operation of the user, determines which of the second verification data are selected by the user, and generates M of the corresponding input data; wherein N is a positive integer greater than 1, and M is a positive integer; and
utilizing the processing module of the secure device to determine whether or not M of the to-be-verified password data match with M of password data that are stored in the secure device in advance;
when the processing module of the secure device determines that M of the to-be-verified password data match with M of the password data, the secure device transmits a verification-successful information to the unsecure device;
when the processing module of the secure device determines that M of the to-be-verified password data do not match with M of the password data, the secure device transmits a verification-failed information to the unsecure device.

2. The verification method according to claim 1, wherein the display unit of the secure device presents each of the first verification data in a form of a character string, the display unit of the secure device presents each of the second verification data in a form of a picture, and the unsecure device includes N buttons, wherein each of the N buttons respectively has corresponding pictures of N of the second verification data presented on the display unit of the secure device.

3. The verification method according to claim 1, wherein before utilizing the processing module of the secure device to substitute M of the first verification data for M of the input data, the verification step further includes a presenting step: utilizing a display unit of the unsecure device to present P of the second verification data, utilizing a processing module of the unsecure device to determine which of the second verification data are selected by the user, and generating M of the input data correspondingly.

4. The verification method according to claim 1, wherein a password pre-storing step is further included before the verification step: storing M of the password data in the secure device; wherein in the password pre-storing step, the secure device receives M of the password data that is transmitted by the unsecure device and stores the password data in a storing unit of the secure device, or, the secure device receives M of the password data that is transmitted by an external device of the unsecure device and stores the password data in the storing unit of the secure device, or, the processing module of the secure device, according to an operation of the user with respect to the secure device, generates M of the corresponding password data, and stores the password data in the storing unit of the secure device.

5. A verification method that is applicable for a secure device and an unsecure device, the secure device including a display unit and a processing module, the unsecure device being capable of generating an input information according to an operation of a user, and the processing module of the secure device being capable of receiving the input information that is transmitted by the unsecure device, the verification method comprising:
a verification code presenting step:
utilizing the processing module of the secure device to generate a match information; wherein the match information includes N of first verification data that are different from one another and N of second verification data that are different from one another, and one-to-one substitution relations between each of N of the first verification data and each of N of the second verification data are presented on the display unit by the match information; wherein the one-to-one substitution relations between each of N of the first verification data and each of N of the second verification data are not entirely identical each time the one-to-one substitution relations are generated by the processing module; and
executing, when the secure device receives the input information within a predetermined period of time after the match information is presented on the display unit, the following steps:
a verification step:
utilizing the processing module of the secure device to substitute M of the first verification data for M of input data of the input information according to the match information; wherein the processing module defines M of the first verification data generated through the substitution as M of to-be-verified password data according to the match information, the unsecure device presents P of the second verification data, and the unsecure device, according to an operation of the user, determines which of the second verification data are selected by the user, and generates M of the corresponding input data; wherein N is a positive integer greater than 1, and M is a positive integer; and
utilizing the processing module of the secure device to determine whether or not M of the to-be-verified password data match with M of password data of the input information;
when the processing module of the secure device determines that M of the to-be-verified password data match with M of the password data, the secure device transmits a verification-successful information to the unsecure device;
when the processing module of the secure device determines that M of the to-be-verified password data do not match with M of the password data, the secure device transmits a verification-failed information to the unsecure device.

6. The verification method according to claim 5, wherein the display unit of the secure device presents each of the first verification data in a form of a character string, the display unit of the secure device presents each of the second verification data in a form of a picture, and the unsecure device includes N buttons, wherein each of the N buttons respectively has corresponding pictures of N of the second verification data presented on the display unit of the secure device.

7. The verification method according to claim 5, wherein before utilizing the processing module of the secure device to substitute M of the first verification data for M of the input data, the verification step further includes a presenting step: utilizing a display unit of the unsecure device to present P of the second verification data and K of encoded data, utilizing a processing module of the unsecure device to determine which of the second verification data are selected by the user, and generating M of the input data correspondingly; wherein M of K of the encoded data are defined as the password data, and K is a positive integer greater than or equal to M.

8. A transaction verification method that is applicable for a secure device and an unsecure device, the secure device including a first display unit and a first processing module, the unsecure device including a second display unit, a second processing module, and an input unit, the transaction verification method comprising:
a transaction information inputting step:
utilizing, according to an operation of the input unit by a user, the second processing module of the unsecure device to generate a corresponding transaction data;
utilizing the second processing module of the unsecure device to execute a R-bit based transfer encoding algorithm that converts the transaction data into an encoded information that is R-bit based, and controlling the second display unit to present K characters of the encoded information; wherein R is a positive integer greater than 1; wherein M characters of the encoded information presented by the second display unit are defined as M of the password data; wherein K is a positive integer greater than or equal to M;
a transaction signature request step:
transmitting, after the second display unit of the unsecure device presents M of the password data, a transaction signature request information to the secure device through the unsecure device;
a transaction verification code presenting step:
utilizing the secure device to receive the transaction signature request information that is transmitted by the unsecure device;
controlling the first processing module of the secure device to generate a match information, with the first display unit presenting the match information; wherein the match information includes N of first verification data that are different from one another and N of second verification data that are different from one another, and one-to-one substitution relations between each of N of the first verification data and each of N of the second verification data are presented on the first display unit by the match information; wherein N is a positive integer that is greater than or equal to 1, and M is a positive integer; wherein the one-to-one substitution relations between each of N of the first verification data and each of N of the second verification data are not identical each time the one-to-one substitution relations are generated by the first processing module; and
executing a signature step, when the secure device receives a to-be-signed information that is transmitted by the unsecure device, within a predetermined period of time after the first display unit presents the match information: wherein the input unit presents P of the second verification data, and the second processing module of the unsecure device determines which of the second verification data are selected by the user through the input unit, and then generates M of the corresponding input data; wherein the second processing module integrates M of the input data and the encoded information into the to-be-signed information;
the signature step including:
utilizing the first processing module of the secure device, to substitute M of the first verification data for M of the input data of the to-be-signed information according to the match information; wherein the first processing module defines M of the first verification data generated through the substitution as M of to-be-verified password data according to the match information;
utilizing the first processing module to determine whether or not M of the to-be-verified password data match with M of the password data;
when the first processing module of the secure device determines that M of the to-be-verified password data match with M of the password data, the first processing module digitally signs the encoded information, and then transmits the digitally signed encoded information back to the unsecure device;
when the first processing module of the secure device determines that M of the to-be-verified password data do not match with M of the password data, the first processing module transmits a signature-failed information to the unsecure device.

9. The transaction verification method according to claim 8, wherein a user verification step is further included before the transaction information inputting step or before the verification code presenting step: executing the verification method as claimed in claim 1, and when the unsecure device receives the verification-successful information from the secure device, the unsecure device then executes the transaction information inputting step or the transaction verification code presenting step.

10. The transaction verification method according to claim 8, wherein the first display unit of the secure device presents each of the first verification data in a form of a character string, the first display unit of the secure device presents each of the second verification data in a form of a picture, and the unsecure device includes N buttons, wherein each of the N buttons respectively has corresponding pictures of N of the second verification data that are presented on the first display unit of the secure device; wherein in the transaction information inputting step, the second processing module of the unsecure device is utilized to execute a hash algorithm, and then execute the R-bit based transfer encoding algorithm, so as to convert the transaction information into the encoded information that is R-bit based.
